(19) United States
(12) Patent Application Publication
(10) Pub. No.: US 2026/0311393 A1
(43) Pub. Date: Oct. 8, 2026

(54) MULTI-FUNCTIONAL GENERATIVE EFFECTS

(71) Applicant: ADOBE INC., SAN JOSE, CA (US)

(72) Inventors: Rishav Agarwal, Bangalore (IN); Sunny Ladkani, Bengaluru (IN); Sanyam Jain, Delhi (IN)

(21) Appl. No.: 19/173,370

(22) Filed: Apr. 8, 2025

(51) Int. Cl. G06T 11/60; G06T 7/11; G06T 7/174

(52) U.S. Cl. CPC G06T 11/60; G06T 7/11; G06T 7/174; G06T 2207/20212

(57) ABSTRACT

A method, apparatus, non-transitory computer readable medium, and system for image generation include obtaining an input image and a mask indicating a region of the input image. An intermediate image is generated, using an image generation model, based on the input image and the mask. The intermediate image differs from the input image within the region indicated by the mask and is similar to the input image outside of the region indicated by the mask. The input image and the intermediate image are combined to obtain a composite image. The composite image includes content from the intermediate image within the region indicated by the mask and content from the input image outside of the region indicated by the mask.

### BACKGROUND

The following relates generally to image processing, and more specifically to image generation using machine learning. Digital image processing refers to the use of a computer to edit a digital image using an algorithm or a processing network. In some cases, image processing software can be used for various tasks, such as image editing, image restoration, image generation, etc. Recently, machine learning models have been used in advanced image processing techniques. Among these machine learning models, diffusion models and other generative models such as generative adversarial networks (GANs) have been used for various tasks including generating images with perceptual metrics, generating images in conditional settings, image inpainting, and image manipulation.

Image generation, a subfield of image processing, involves the use of diffusion models to synthesize images. Diffusion models can be used for various image generation tasks including image super-resolution, generation of images with perceptual metrics, conditional generation (e.g., generation based on text guidance), image inpainting, and image manipulation. Specifically, diffusion models are trained to take random noise as input and generate unseen images with features similar to the training data.

### SUMMARY

The present disclosure describes systems and methods for image generation. Embodiments of the present disclosure include an image generation apparatus that receives an input image and a mask indicating a region of the input image. The image generation apparatus performs targeted object editing by skipping one or more diffusion steps of the diffusion process based on a sampling interval parameter (e.g., SDEdit) and a mask based diffusion technique (e.g., DiffEdit). In some embodiments, an image generation model generates an intermediate image based on the input image and the mask, where the intermediate image differs from the input image within the region indicated by the mask and is similar to the input image outside of the region indicated by the mask. The input image and the intermediate image are combined to obtain a composite image. During the process of generating the intermediate image, some embodiments perform a first phase of a diffusion process based on the mask and perform a second phase of the diffusion process independent of the mask. The first phase precedes the second phase.

A method, apparatus, non-transitory computer readable medium, and system for image processing are described. One or more embodiments of the method, apparatus, non-transitory computer readable medium, and system include obtaining an input image and a mask indicating a region of the input image; generating, using an image generation model, an intermediate image based on the input image and the mask, wherein the intermediate image differs from the input image within the region indicated by the mask and is similar to the input image outside of the region indicated by the mask; and combining the input image and the intermediate image to obtain a composite image, wherein the composite image includes content from the intermediate image within the region indicated by the mask and content from the input image outside of the region indicated by the mask.

A method, apparatus, non-transitory computer readable medium, and system for image processing are described. One or more embodiments of the method, apparatus, non-transitory computer readable medium, and system include obtaining an input image and a mask indicating a region of the input image; performing, using an image generation model, a first phase of a diffusion process based on the mask; performing, using the image generation model, a second phase of the diffusion process independent of the mask; and generating, using the image generation model, a synthetic image based on the first phase and the second phase, wherein the synthetic image comprises a structural similarity to the input image.

An apparatus, system, and method for image processing are described. One or more embodiments of the apparatus, system, and method include a memory component; a processing device coupled to the memory component, the processing device configured to perform operations comprising: obtaining an input image and a mask indicating a region of the input image; generating, using an image generation model, an intermediate image based on the input image and the mask, wherein the intermediate image differs from the input image within the region indicated by the mask and is similar to the input image outside of the region indicated by the mask; and combining the input image and the intermediate image to obtain a composite image, wherein the composite image includes content from the intermediate image within the region indicated by the mask and content from the input image outside of the region indicated by the mask.

### BRIEF DESCRIPTION OF THE DRAWINGS

FIG. 1 shows an example of an image processing system according to aspects of the present disclosure.

FIG. 2 shows an example of a method for conditional media generation according to aspects of the present disclosure.

FIG. 3 shows an example of composite images according to aspects of the present disclosure.

FIG. 4 shows an example of vector-to-realistic image generation according to aspects of the present disclosure.

FIG. 5 shows an example of a method for image processing according to aspects of the present disclosure.

FIG. 6 shows an example of an image processing apparatus according to aspects of the present disclosure.

FIG. 7 shows an example of a method for operating a machine learning model according to aspects of the present disclosure.

FIG. 8 shows an example of a guided diffusion model according to aspects of the present disclosure.

FIG. 9 shows an example of a U-Net architecture according to aspects of the present disclosure.

FIG. 10 shows an example of a diffusion process according to aspects of the present disclosure.

FIG. 11 shows an example of an image generation model comprising a control network according to aspects of the present disclosure.

FIG. 12 shows an example of a control network of an image generation model according to aspects of the present disclosure.

FIG. 13 shows an example of a method for image processing according to aspects of the present disclosure.

FIG. 14 shows an example of a method for generating a composite image according to aspects of the present disclosure.

FIG. 15 shows an example of applying effect to a segment of an input image according to aspects of the present disclosure.

FIG. 16 shows an example of an intermediate image according to aspects of the present disclosure.

FIG. 17 shows an example of combining an input image and an intermediate image according to aspects of the present disclosure.

FIG. 18 shows an example of composite images by changing a sampling interval parameter according to aspects of the present disclosure.

FIG. 19 shows an example of a method for image processing according to aspects of the present disclosure.

FIG. 20 shows an example of a vector image as input according to aspects of the present disclosure.

FIG. 21 shows an example of a mask and an edge image according to aspects of the present disclosure.

FIG. 22 shows an example of a realistic image according to aspects of the present disclosure.

FIG. 23 shows an example of synthetic images by changing a sampling interval parameter according to aspects of the present disclosure.

FIG. 24 shows an example of a process for training a diffusion model according to aspects of the present disclosure.

FIG. 25 shows an example of a step-by-step procedure for training a machine learning model according to aspects of the present disclosure.

FIG. 26 shows an example of a computing device for image processing according to aspects of the present disclosure.

### DETAILED DESCRIPTION

The present disclosure describes systems and methods for image generation. Embodiments of the present disclosure include an image generation apparatus that receives an input image and a mask indicating a region of the input image. The image generation apparatus performs targeted object editing by skipping one or more diffusion steps of the diffusion process based on a sampling interval parameter (e.g., SDEdit) and a mask based diffusion technique (e.g., DiffEdit). In some embodiments, an image generation model generates an intermediate image based on the input image and the mask, where the intermediate image differs from the input image within the region indicated by the mask and is similar to the input image outside of the region indicated by the mask. The input image and the intermediate image are combined to obtain a composite image. During the process of generating the intermediate image, some embodiments perform a first phase of a diffusion process based on the mask and perform a second phase of the diffusion process independent of the mask. The first phase precedes the second phase.

In the field of digital content generation, large-scale text-to-image (T2I) diffusion models are popular tools. Diffusion models are a class of generative neural networks that can be trained to generate new data with features similar to features found in training data. Diffusion models can be used in image synthesis, image completion tasks, etc. Some content creators have to create masks and add an object in a masked region. But conventional models often struggle with blending the new object with the rest of the original image. Content creators have to spend hours removing artifacts or re-styling synthesized images. For example, conventional diffusion models may not apply a particular effect on a jacket, or they apply unexpected effects that are not consistent with the rest of the image. Therefore, conventional models are not able to swap an object into an image while preserving the style and consistency of the image resulting in unsatisfactory visual qualities (i.e., fall short of harmonious object transition, especially on the edges of blending).

Embodiments of the present disclosure include an image generation apparatus that obtain an input image and a mask indicating a region of the input image. An image generation model (e.g., a diffusion model) performs a first phase of a diffusion process based on the mask. The image generation model performs a second phase of the diffusion process independent of the mask. The image generation model generates a synthetic image based on the first phase and the second phase, where the synthetic image comprises a structural similarity to the input image.

In some embodiments, the image generation model performs a first phase of a diffusion process based on the mask. Then the image generation model performs a second phase of the diffusion process independent of the mask. The first phase precedes the second phase. In some examples, a sampling interval parameter is identified such that the first phase is based on the sampling interval parameter. The image generation model skips one or more diffusion steps of the diffusion process based on the sampling interval parameter. By skipping the one or more diffusion steps (e.g., SDEdit), the image generation model starts from an intermediate image. In some examples, a masking interval parameter is identified such that the first phase is based on the masking interval parameter.

In some examples, “first diffusion phase” or “first phase” may refer to a phase or a set of time steps applying DiffEdit based on the mask. The first phase is based on the masking interval parameter. DiffEdit is about inferring a mask that accurately identifies a region from an input image that needs to be changed (to match an input query). DiffEdit involves computing an editing mask. This way, the image generation model knows exactly the location of the region for editing. In some cases, the first phase begins right after one or more time steps of a diffusion process are skipped. In some examples, “second diffusion process” or “second phase” may refer to a next phase or a set of time steps immediate after the first phase. The image generation model performs the second phase of the diffusion process independent of the mask.

In some examples, SDEdit may be used to generate a realistic image based on a naive input (e.g., stroke painting as guide). The key here is selecting to, i.e., the time from which a model begins a reverse diffusion process. For example, to does not need to be 1. Here, t∈[0, 1] indexes time. SDEdit relies on the fact that reverse SDE can be solved not only from t₀=1, but also from any intermediate time t₀ ∈(0, 1). In some examples, a sweet spot t₀ ∈[0.3, 0.6] for reasonable guides. It means any parameter in this range can achieve a balanced tradeoff between being faithful to an original image and realistic.

A “sampling interval parameter” is used to determine skipping one or more diffusion/sampling steps. The sampling interval parameter makes the model skip 30% of the diffusion steps in the beginning. For example, if it takes 50 time steps to get a clean final output, the model would start from the 16th time step (which is a less noisy image input as a starting point. In addition, the “sampling interval parameter” indicates a (less noisy) starting image input in a diffusion process. If a sampling interval parameter=0.3 (i.e., to =0.3), SDEdit does not start from random noise. For example, the entire image is used as the initial image. This ensures that the area outside the masked region remains the same as the original image during the time when DiffEdit is being performed.

For example, the sampling interval parameter is set to 0.3 while the masking interval parameter is set to [0, 0.5]. Suppose an image is generated by starting from random noise (0%) and at 100%, the image generation model gets the final generated image. By applying SDEdit, the image generation model does not start from random noise and instead uses an image as starting point. Since the sampling interval parameter is set to 0.3, 30% of initial generation process are to be skipped and the model will start image generation from this point with the input image as base. If no SDEdit is applied, DiffEdit process would start right from 0%. Since 30% of the steps are skipped, DiffEdit goes from 30% till 50% (for 0.5 masking interval parameter).

In some embodiments, a user selects an input image and wants to edit the image. An image segmentation model segments the input image to obtain a set of masked regions. The user selects a target segment within the input image where the user wants to apply the effect. The user types in the effect to be applied to the target segment, e.g., “A t-shirt made of tiger fur”. The image generation model described above can create the effect on segmented area. The image generation model applies a combination of SDEdit, DiffEdit, and structure match to create effects in such a way that it can be seamlessly stitched back into the original image. By applying DiffEdit, the image generation model uses the segmented region which was selected by the user as the mask image. in some examples, the masking interval is set to [0, 0.85]. This ensures that the model generates effect within the masked region for 85% of the time steps. By applying SDEdit, the image generation model uses the entire image as the initial image. This ensures that the area outside the masked region remains the same as the original image during the time when DiffEdit is being performed. This ensures that stitching the effect back into the original image is seamless and natural. Additionally, it provides flexibility for the effect to be either more creative or closer to the original image.

If an extremely low sampling interval is selected, then the image generation model creates an effect which is more creative and distinct from the original image. In some cases, if users want the output to be closer to the original image and less creative, they can increase the sampling interval to achieve this effect. This setting is provided to users as a creativity slider. If the original content has some lighting, shadows, and colors, then all that information is preserved more as users increase the sampling interval.

In an embodiment, the original image is used again as structure match (canny data) so that edges in original image are preserved. This way, the generated segment has the same folds and curves as the original segment. The output from the model after performing the above steps is called an intermediate image or an intermediate output. The intermediate image includes the desired effect in the masked region. The area outside the masked region resembles the original image closely-hence ensuring superior stitching performance in the next step (i.e., stitching of effect on the original image).

Once the intermediate image is generated, the image generation model performs the stitching operation. The image generation model uses the mask image for this operation. The model replaces the pixels of the original image corresponding to the white regions of the mask with the pixels in the intermediate image. Through applying pixels from intermediate image back into original image, the model ensures that the intermediate image is substantially similar to the original image in non-masked region. Therefore, the model generates desired output with low computation cost while ensuring high quality stitching.

In an embodiment, the image generation apparatus combines the input image and the intermediate image to generate a synthetic image. The synthetic image preserves the unmasked region's attributes (e.g., color, structure, texture, size, etc.). The intermediate image (corresponding to the masked region) and the unmasked region are combined seamlessly to obtain the synthetic image.

In some examples, the input image comprises a vector image and the synthetic image comprises a detailed depiction of a scene of the vector image. A user clicks on a vector image and wants to create a realistic image based on the vector image. The user describes the illustration, e.g., “An airport with view of an aero plane taking off”. In some embodiments, the image generation model removes all the styles, fill and stroke properties applied to the vector image. Then, the image generation model fills all the closed paths within the SVG with white color, while the model fills the strokes with black color. This provides the mask image to be used for DiffEdit. The model inverts the colors to create an edge image.

The present disclosure describes systems and methods that improve on conventional image generation models by increasing the accuracy of effect/style applied to a segment of an input image. For example, users select a segment of the input image, and a mask is obtained in the shape of the selected segment. The image generation model generates an intermediate image based on the input image and the mask. The intermediate image differs from the input image within the region indicated by the mask and is similar to the input image outside of the region indicated by the mask. Then the intermediate image is stitched together with the input image to obtain a composite image. The accuracy of applying effect/style is improved because the composite image includes similar contextual information from the input image and generated content from the intermediate image and preserves structural information of the input image.

The image generation model generates a realistic image by applying a combination of SDEdit, DiffEdit, and structure match in the following way. For DiffEdit, the image generation model uses the mask image created above. The masking interval is set to [0, 0.55]. A high masking interval is set such that the original illustration is faithfully recreated as a realistic image. For SDEdit, the image generation model uses the original image as the initial image. The model keeps a low sampling interval of 0.15, which ensures that the model starts using the original image as the starting point and adds realistic effect to it. The edge image created above is used as structure match data (canny data) so that the edges in the original illustration are preserved. The image generation model faithfully recreates the vector image as a realistic image. The combined application of SDEdit, DiffEdit, and structure match results in stronger adherence to edges and increased control over the output.

In some examples, “input image” refers to a digital image such as a vector image made of mathematical paths or a raster image made of pixels. The “vector image” is constructed using mathematic paths and shapes such as lines, points, curves, polygons, etc. The vector image may have a file format such as scalable vector graphic (“SVG”) or encapsulated postscript (“EPS”).

In some examples, a “mask” in image segmentation is a binary or multi-class map where each pixel is labeled as belonging to a certain class (e.g., foreground vs. background). The mask may be used to indicate a region of the input image such that effect or change may be applied within the region indicated by the mask. In some cases, a region of the input image indicated by the mask has a regular shape or an irregular shape, e.g., a shape corresponding to a t-shirt.

The term “intermediate image” refers to an image generated using a diffusion model by performing the first phase of a diffusion process and the second phase of the diffusion process as described in the present disclosure. The intermediate image differs from the input image within the region indicated by the mask and is similar to the input image outside of the region indicated by the mask. For example, the image generation model may be trained or prompted to generate similar content to the input image outside the mask region and different content inside the mask region. The term “composite image” refers to a final output image after combing the input image and the intermediate image.

### Image Processing

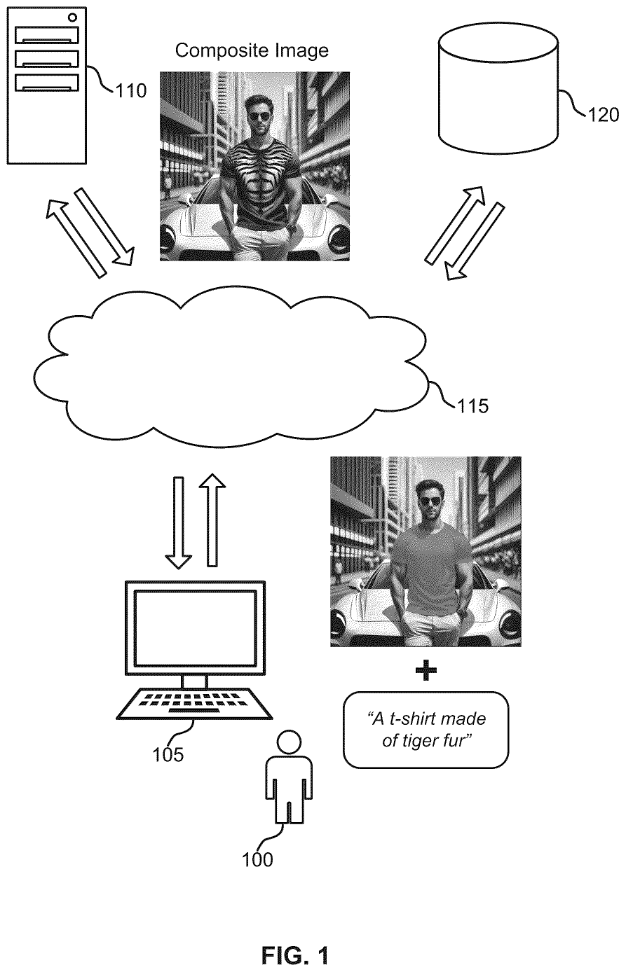

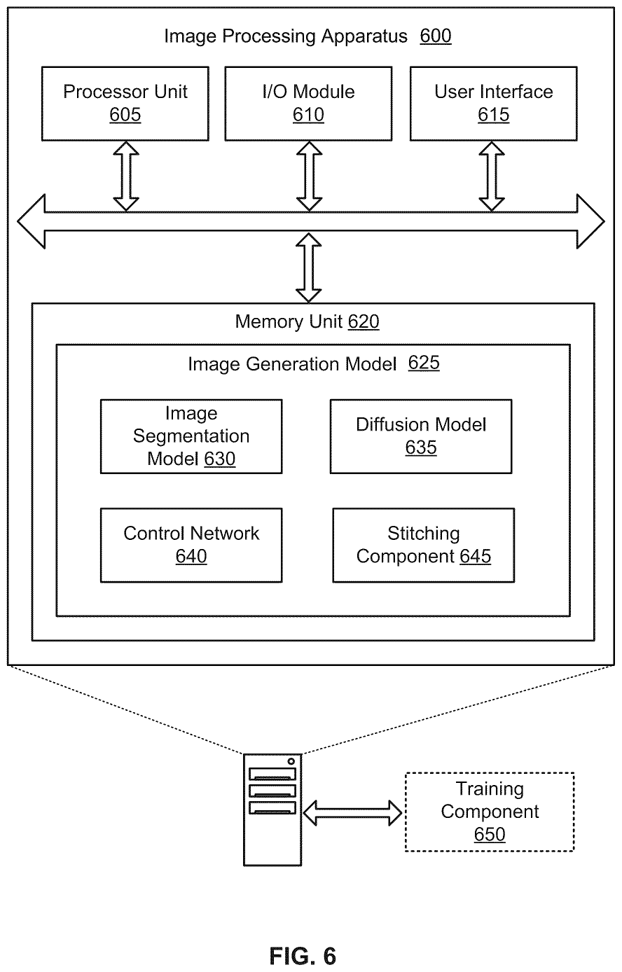

FIG. 1 shows an example of an image processing system according to aspects of the present disclosure. The example shown includes user 100, user device 105, image processing apparatus 110, cloud 115, and database 120. Image processing apparatus 110 is an example of, or includes aspects of, the corresponding element described with reference to FIG. 6.

In an example shown in FIG. 1, an input image is provided by user 100. The input image depicts a man in a black shirt standing in front of a car on a street. Additionally, a text prompt indicating a style of an object is provided by user 100. The text prompt is “A t-shirt made of tiger fur”. The text prompt indicates an effect that image processing apparatus 110 applies to the input image, namely changing the man's black shirt to one made of tiger fur. The input image and the text prompt are transmitted to image processing apparatus 110, e.g., via user device 105 and cloud 115.

Image processing apparatus 110 obtains a mask indicating a region of the input image, and generates an intermediate image based on the input image and the mask. Here the mask includes an area corresponding to the shirt of the input image. In some examples, the intermediate image differs from the input image within the region indicated by the mask (e.g., the area corresponding to the shirt), and is similar to the input image outside of the region indicated by the mask (e.g., background scene is preserved to look substantially similar to the input image). The intermediate image also depicts a man similar to the input image, and the man stands in front of a same car on a street similar to the input image. In the masked region, the intermediate image depicts a shirt made of tiger fur. In some cases, the region in the intermediate image indicated by the mask includes the style or effect from the text prompt.

Image processing apparatus 110 combines the input image and the intermediate image to obtain a composite image. The composite image includes content from the intermediate image within the region indicated by the mask and content from the input image outside of the region indicated by the mask. Image processing apparatus 110 returns the composite image to user 100 via cloud 115 and user device 105. The composite image depicts the same man standing in front of the same car on the street similar to the input image, but the shirt of the man is made of tiger fur consistent with the intermediate image. In some examples, the composite image includes a seamless transition between the content from the input image outside of the region (e.g., face, arm, leg, car, and street) indicated by the mask and the content from the intermediate image within the region indicated by the mask (e.g. a shirt made of tiger fur).

User device 105 may be a personal computer, laptop computer, mainframe computer, palmtop computer, personal assistant, mobile device, or any other suitable processing apparatus. In some examples, user device 105 includes software that incorporates an image processing application (e.g., an image generator, an image editing tool). In some examples, the image processing application on user device 105 may include functions of image processing apparatus 110.

A user interface may enable user 100 to interact with user device 105. In some embodiments, the user interface may include an audio device, such as an external speaker system, an external display device such as a display screen, or an input device (e.g., a remote-control device interfaced with the user interface directly or through an I/O controller module). In some cases, a user interface may be a graphical user interface (GUI). In some examples, a user interface may be represented in code which is sent to the user device 105 and rendered locally by a browser.

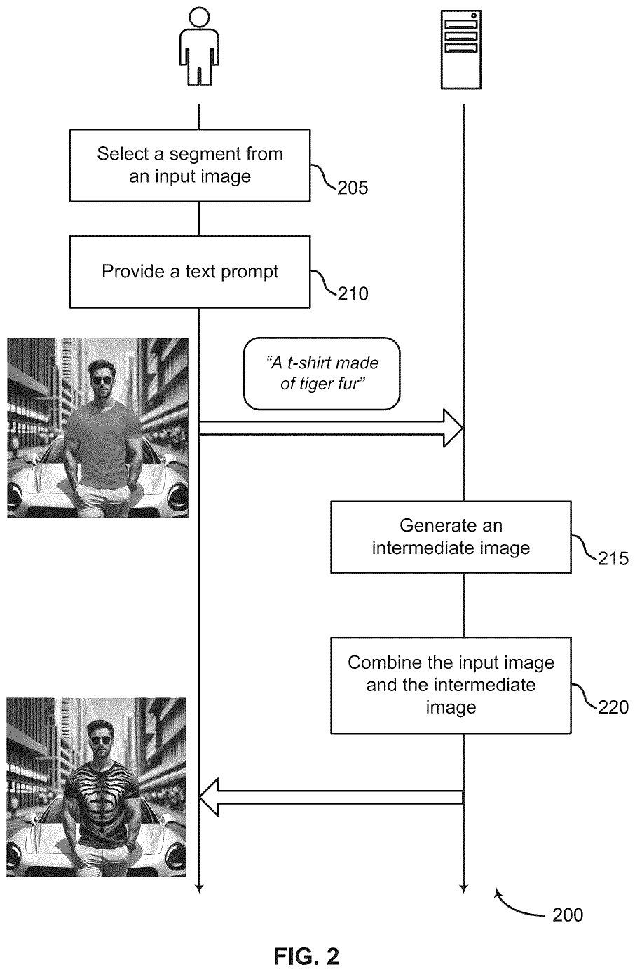

Image processing apparatus 110 includes a computer-implemented network comprising an image segmentation model, a diffusion model, a control network, and a stitching component. Image processing apparatus 110 may also include a processor unit, a memory unit, an I/O module, and a user interface. A training component may be implemented on an apparatus other than image processing apparatus 110. The training component is used to train a machine learning model. Additionally, image processing apparatus 110 can communicate with database 120 via cloud 115. In some cases, the architecture of the image generation network is also referred to as a network, a machine learning model, or a network model. Further detail regarding the architecture of image processing apparatus 110 is provided with reference to FIGS. 6-12. Further detail regarding the operation of image processing apparatus 110 is provided with reference to FIGS. 2, 5, and 13-23.

In some cases, image processing apparatus 110 is implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a supercomputer, or any other suitable processing apparatus.

Cloud 115 is a computer network configured to provide on-demand availability of computer system resources, such as data storage and computing power. In some examples, cloud 115 provides resources without active management by the user. The term “cloud” is sometimes used to describe data centers available to many users over the Internet. Some large cloud networks have functions distributed over multiple locations from central servers. A server is designated an edge server if it has a direct or close connection to a user. In some cases, cloud 115 is limited to a single organization. In other examples, cloud 115 is available to many organizations. In one example, cloud 115 includes a multi-layer communications network comprising multiple edge routers and core routers. In another example, cloud 115 is based on a local collection of switches in a single physical location.

Database 120 is an organized collection of data. For example, database 120 stores data (e.g., dataset for training a diffusion model) in a specified format known as a schema. Database 120 may be structured as a single database, a distributed database, multiple distributed databases, or an emergency backup database. In some cases, a database controller may manage data storage and processing in database 120. In some cases, a user interacts with the database controller. In other cases, database controllers may operate automatically without user interaction.

FIG. 2 shows an example of a method 200 for conditional media generation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 205, the user selects a segment from an input image. In some cases, an “input image” refers to a digital image such as a vector image made of mathematical paths or a raster image made of pixels. The raster image may be referred to as a realistic image. In some cases, the “segment” refers to a target region as indicated by a mask, and the user operates an image generation model to apply an effect, style or change to the segment. The intermediate image (or an intermediate output) includes the desired effect in the masked region. The intermediate image differs from the input image within the region indicated by the mask. The intermediate image is similar to the input image outside of the region indicated by the mask, ensuring superior stitching performance and seamless transition. In the example as shown in FIG. 2, the input image depicts a man in a black shirt standing in front of a car on a street, and the segment refers to a region corresponding to the black shirt. In some cases, the operations of this step refer to, or may be performed by, a user as described with reference to FIG. 1.

At operation 210, the user provides a text prompt. In some cases, a text prompt refers one or more phrases that indicate an effect applied to an element in the text prompt and/or the input image. The text prompt guides the image generation process (e.g., text guidance). The text prompt mentions the target region. In the above example, the text prompt is “A t-shirt made of tiger fur”. In some cases, the operations of this step refer to, or may be performed by, a user as described with reference to FIG. 1.

At operation 215, the system generates an intermediate image based on the input image, the selected segment, and the text prompt. In some cases, the intermediate image is generated using an image generation model. In some examples, the intermediate image differs from the input image within the region indicated by the mask (e.g., the shirt), and is similar to the input image outside of the region indicated by the mask. For example, The man's face, arm, and leg are similar to the input image, and the man stands in front of a car on a street similar to the input image. Within the region indicated by the mask, the intermediate image depicts a shirt made of tiger fur consistent with the text guidance. In some cases, generating the intermediate image includes a process of performing a first phase of a diffusion process based on the mask and performing a second phase of the diffusion process independent of the mask, where the first phase precedes the second phase. In some cases, the operations of this step refer to, or may be performed by, an image processing apparatus as described with reference to FIGS. 1 and 6.

At operation 220, the system combines the input image and the intermediate image to obtain a composite image. In some examples, the composite image includes content from the intermediate image within the region indicated by the mask and content from the input image outside of the region indicated by the mask. The composite image includes a seamless transition between the content from the input image outside of the region (e.g. face, arm, leg, car, and street as shown in the above example) indicated by the mask and the content from the intermediate image within the region indicated by the mask (e.g. a shirt made of tiger fur as shown in the example). In the composite image, the same man stands in front of the car on the street similar to the input image, while the shirt is made of tiger fur consistent with the intermediate image. In some cases, the operations of this step refer to, or may be performed by, an image processing apparatus as described with reference to FIGS. 1 and 6.

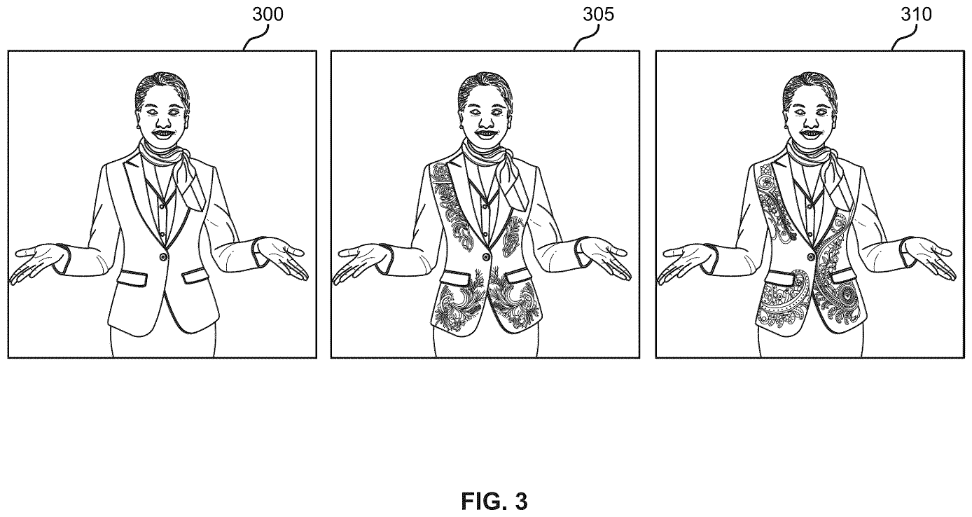

FIG. 3 shows an example of composite images according to aspects of the present disclosure. The example shown includes input image 300, first composite image 305, and second composite image 310. As an example shown in FIG. 3, image generation model 625 described with reference to FIG. 6 generates first composite image 305 and second composite image 310 based on input image 300. Image generation model 625 applies effects on a jacket as a user desires without changing the underlying apparel. For example, image generation model 625 can preserve the overall shape and style of the jacket. Image generation model 625 provides visually compelling results with intuitive way to segment regions and text prompts. It enables users to playfully create realistic effects with minimal effort.

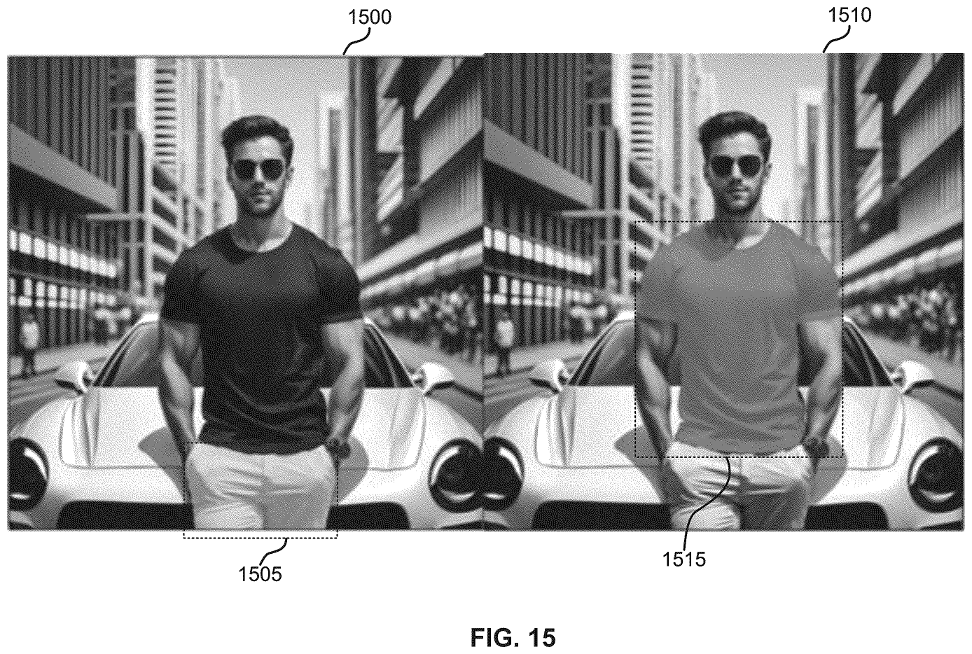

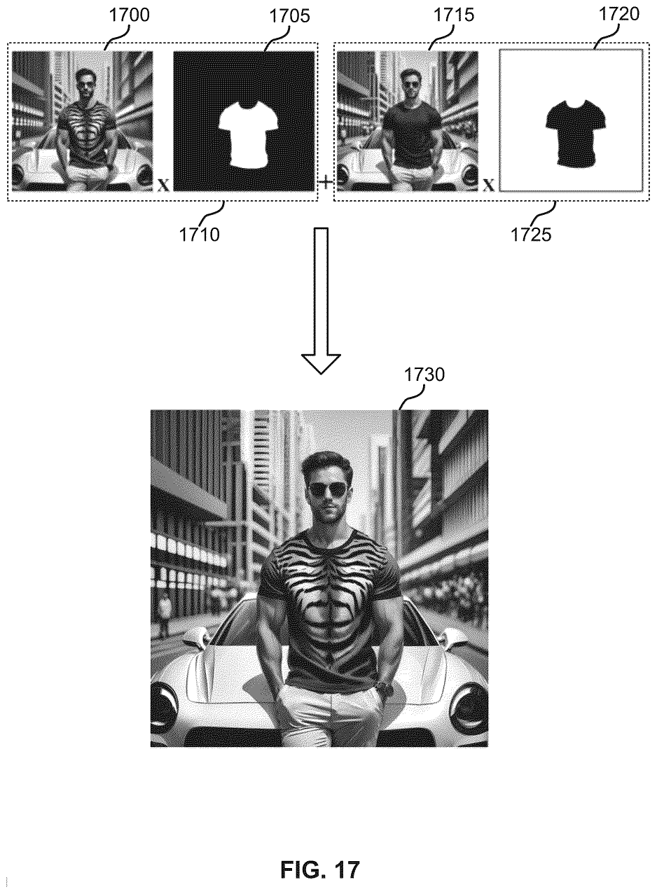

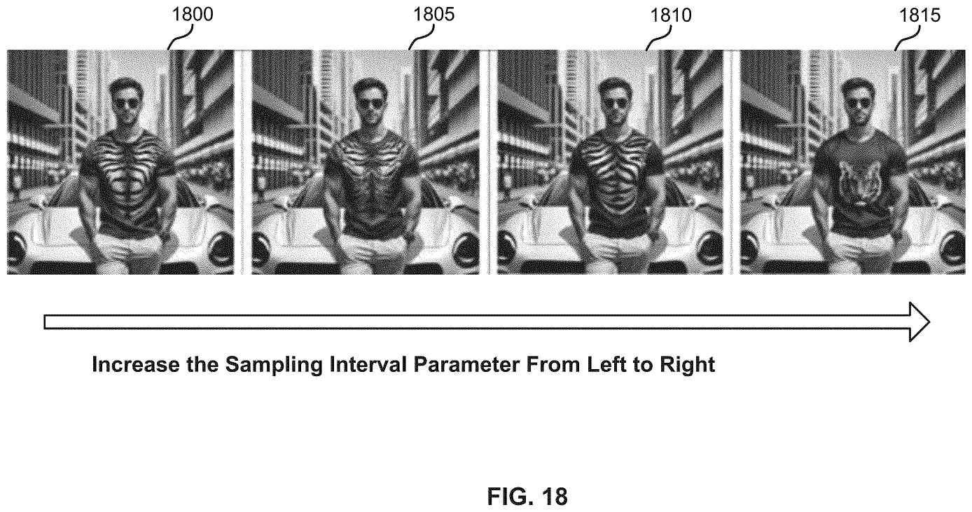

Input image 300 is an example of, or includes aspects of, the corresponding element described with reference to FIGS. 15 and 17. First composite image 305 is an example of, or includes aspects of, the corresponding element described with reference to FIG. 18. Second composite image 310 is an example of, or includes aspects of, the corresponding element described with reference to FIG. 18.

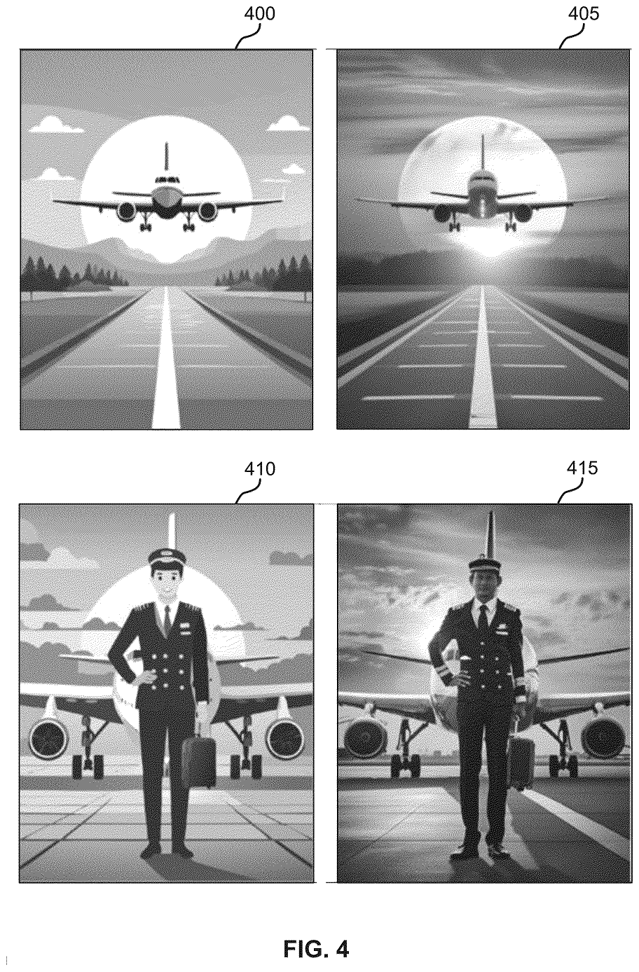

FIG. 4 shows an example of vector to realistic image generation according to aspects of the present disclosure. The example shown includes first vector image 400, first synthetic image 405, second vector image 410, and second synthetic image 415.

As an example show in FIG. 3, image generation model 625 described with reference to FIG. 6 generates first synthetic image 405 based on first vector image 400 and a text prompt (e.g., “a plane taking off at sunset”). The first synthetic image 405 comprises a detailed depiction of a scene of the first vector image 400. Image generation model 625 generates second synthetic image 415 based on second vector image 410 and a text prompt (e.g., “a flight attendant in front of an airplane on a tarmac”). The second synthetic image 415 comprises a detailed depiction of a scene of the second vector image 410.

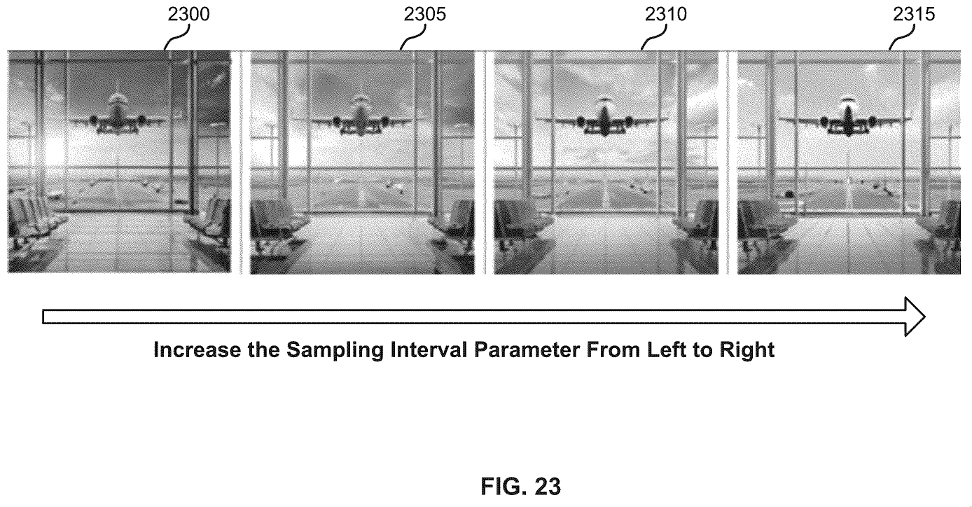

First synthetic image 405 is an example of, or includes aspects of, the corresponding element described with reference to FIG. 23. Second synthetic image 415 is an example of, or includes aspects of, the corresponding element described with reference to FIG. 23.

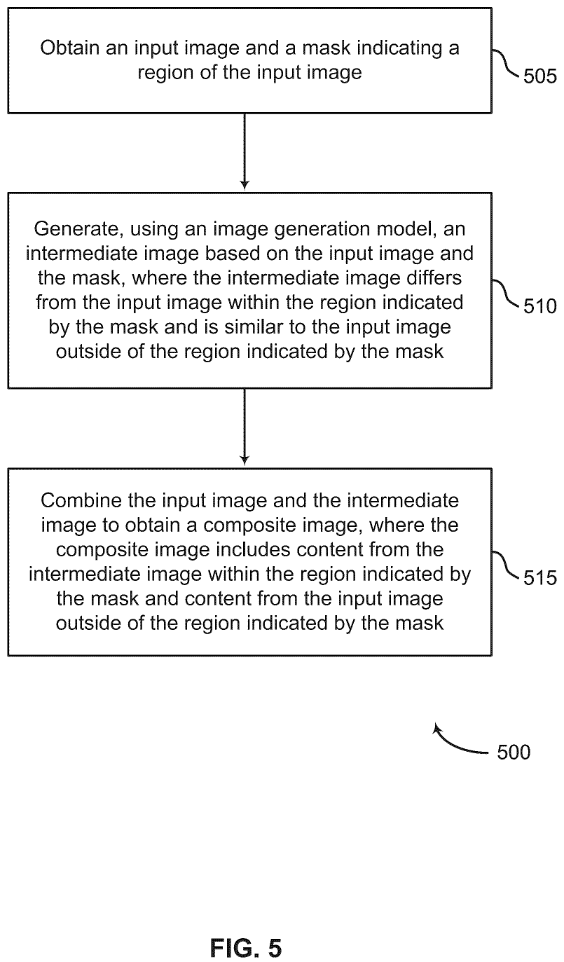

FIG. 5 shows an example of a method 500 for image processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 505, the system obtains an input image and a mask indicating a region of the input image. In some examples, an “input image” refers to a digital image such as a vector image made of mathematical paths or a raster image made of pixels. In some examples, a “mask” in image segmentation is a binary or multi-class map where each pixel is labeled as belonging to a certain class (e.g., foreground vs. background). The mask may be used to indicate a region of the input image such that effect or change may be applied within the region indicated by the mask. In some cases, a region of the input image indicated by the mask has a regular shape or an irregular shape, e.g., a shape corresponding to a t-shirt. In some cases, the operations of this step refer to, or may be performed by, an image generation model as described with reference to FIG. 6.

At operation 510, the system generates, using an image generation model, an intermediate image based on the input image and the mask, where the intermediate image differs from the input image within the region indicated by the mask and is similar to the input image outside of the region indicated by the mask. The “intermediate image” is generated using a diffusion model (e.g., U-Net, Diffusion Transformer) performing a diffusion process. In some cases, the operations of this step refer to, or may be performed by, an image generation model as described with reference to FIG. 6.

At operation 515, the system combines the input image and the intermediate image to obtain a composite image, where the composite image includes content from the intermediate image within the region indicated by the mask and content from the input image outside of the region indicated by the mask. In some cases, the input image is a vector image and the composite image is a realistic image. In some cases, both the input image and the composite image are realistic images. In some cases, the operations of this step refer to, or may be performed by, a stitching component as described with reference to FIG. 6.

In FIGS. 1-5, a method, apparatus, non-transitory computer readable medium, and system for image processing are described. One or more embodiments of the method, apparatus, non-transitory computer readable medium, and system include obtaining an input image and a mask indicating a region of the input image; generating, using an image generation model, an intermediate image based on the input image and the mask, wherein the intermediate image differs from the input image within the region indicated by the mask and is similar to the input image outside of the region indicated by the mask; and combining the input image and the intermediate image to obtain a composite image, wherein the composite image includes content from the intermediate image within the region indicated by the mask and content from the input image outside of the region indicated by the mask.

Some examples of the method, apparatus, non-transitory computer readable medium, and system further include obtaining a condition input indicating a transformation to a first content within the region indicated by the mask, wherein the intermediate image is generated based on the condition input, and wherein the intermediate image includes the transformation to the first content within the region indicated by the mask.

Some examples of the method, apparatus, non-transitory computer readable medium, and system further include segmenting the input image.

Some examples of the method, apparatus, non-transitory computer readable medium, and system further include performing a first phase of a diffusion process based on the mask. Some examples further include performing a second phase of the diffusion process independent of the mask, wherein the first phase precedes the second phase.

Some examples of the method, apparatus, non-transitory computer readable medium, and system further include identifying a sampling interval parameter, wherein the first phase is based on the sampling interval parameter.

Some examples of the method, apparatus, non-transitory computer readable medium, and system further include skipping one or more diffusion steps of the diffusion process based on the sampling interval parameter.

Some examples of the method, apparatus, non-transitory computer readable medium, and system further include identifying a masking interval parameter, wherein the first phase is based on the masking interval parameter.

Some examples of the method, apparatus, non-transitory computer readable medium, and system further include extracting structural information from the input image, wherein the structural information is provided as input to the image generation model, and wherein the intermediate image has a same structure as the input image outside of the region indicated by the mask based on the structural information.

Some examples of the method, apparatus, non-transitory computer readable medium, and system further include producing a first masked image based on the mask and the input image, wherein the first masked image includes the content from the input image outside of the region indicated by the mask. Some examples further include producing a second masked image based on the mask and the intermediate image, wherein the second masked image includes the content from the intermediate image within the region indicated by the mask. Some examples further include combining the first masked image and the second masked image to obtain the composite image.

In some examples, the composite image comprises a seamless transition between the content from the input image outside of the region indicated by the mask and the content from the intermediate image within the region indicated by the mask based on a similarity between them.

### Network Architecture

FIG. 6 shows an example of an image processing apparatus 600 according to aspects of the present disclosure. The example shown includes image processing apparatus 600, processor unit 605, I/O module 610, user interface 615, memory unit 620, image generation model 625, and training component 650. Image processing apparatus 600 is an example of, or includes aspects of, the corresponding element described with reference to FIG. 1.

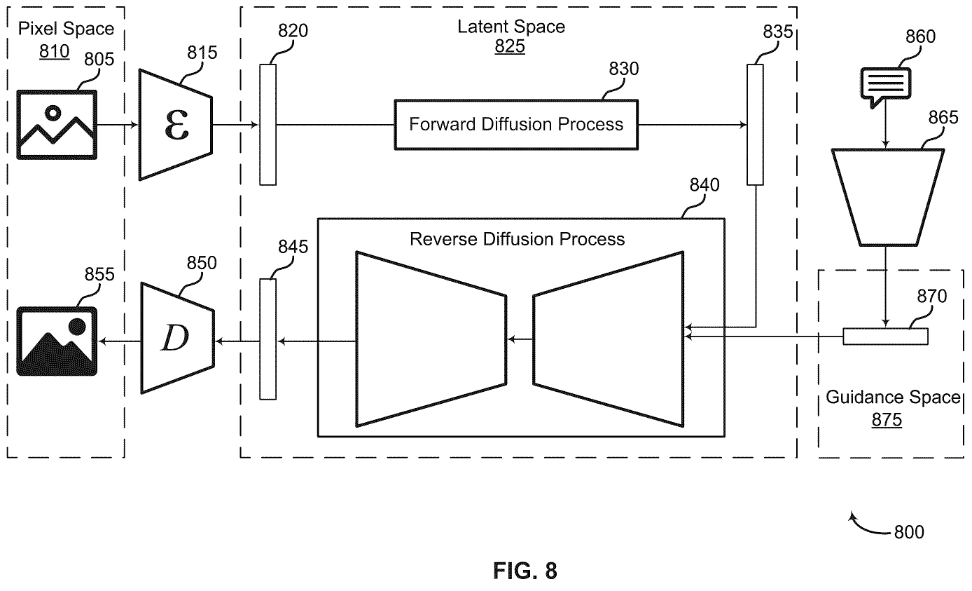

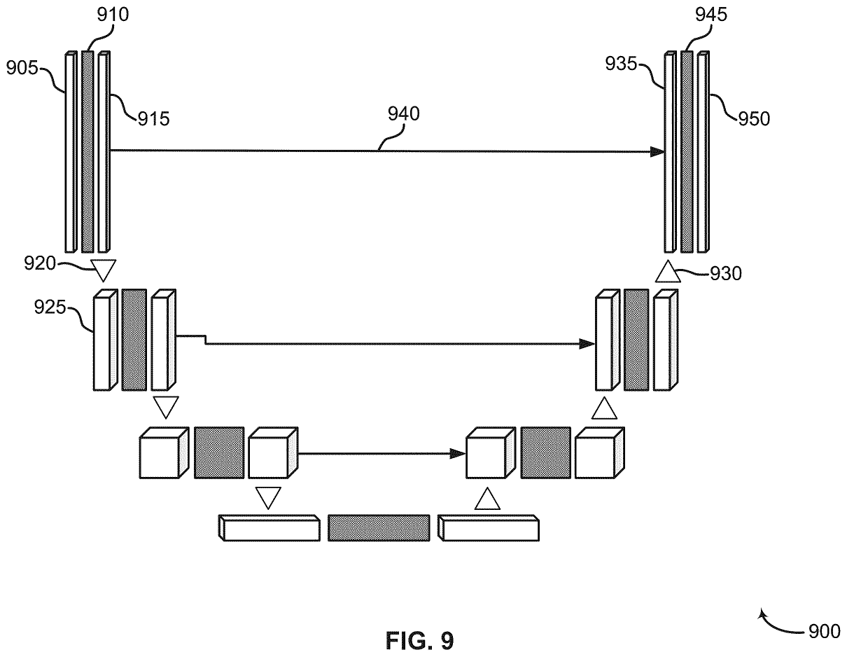

Image processing apparatus 600 may include an example of, or aspects of, the guided diffusion model described with reference to FIG. 8 and the U-Net described with reference to FIG. 9. In some embodiments, image processing apparatus 600 includes processor unit 605, I/O module 610, user interface 615, memory unit 620, image generation model 625, and training component 650. Training component 650 updates parameters of the image generation model 625 stored in memory unit 620. In some examples, the training component 650 is located outside of image processing apparatus 600.

Processor unit 605 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

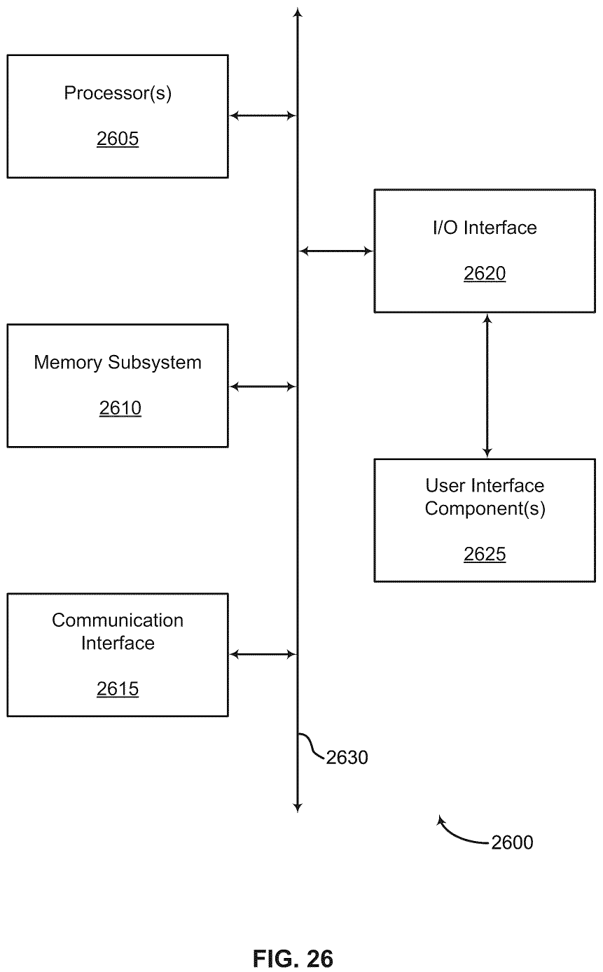

In some cases, processor unit 605 is configured to operate a memory array using a memory controller. In other cases, a memory controller is integrated into processor unit 605. In some cases, processor unit 605 is configured to execute computer-readable instructions stored in memory unit 620 to perform various functions. In some aspects, processor unit 605 includes special purpose components for modem processing, baseband processing, digital signal processing, or transmission processing. According to some aspects, processor unit 605 comprises one or more processors described with reference to FIG. 26.

Memory unit 620 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 605 to perform various functions described herein.

In some cases, memory unit 620 includes a basic input/output system (BIOS) that controls basic hardware or software operations, such as an interaction with peripheral components or devices. In some cases, memory unit 620 includes a memory controller that operates memory cells of memory unit 620. For example, the memory controller may include a row decoder, column decoder, or both. In some cases, memory cells within memory unit 620 store information in the form of a logical state. According to some aspects, memory unit 620 is an example of the memory subsystem 2610 described with reference to FIG. 26.

According to some aspects, image processing apparatus 600 uses one or more processors of processor unit 605 to execute instructions stored in memory unit 620 to perform functions described herein. For example, image processing apparatus 600 may obtain an input image and a mask indicating a region of the input image; generate, using image generation model 625, an intermediate image based on the input image and the mask, wherein the intermediate image differs from the input image within the region indicated by the mask and is similar to the input image outside of the region indicated by the mask; and combine the input image and the intermediate image to obtain a composite image, wherein the composite image includes content from the intermediate image within the region indicated by the mask and content from the input image outside of the region indicated by the mask.

The memory unit 620 may include an image generation model 625 trained to obtain an input image and a mask indicating a region of the input image; generate an intermediate image based on the input image and the mask, wherein the intermediate image differs from the input image within the region indicated by the mask and is similar to the input image outside of the region indicated by the mask; and combine the input image and the intermediate image to obtain a composite image, wherein the composite image includes content from the intermediate image within the region indicated by the mask and content from the input image outside of the region indicated by the mask. For example, after training, the image generation model 625 may perform inferencing operations as described with reference to FIGS. 2 and 5.

In some embodiments, the image generation model 625 is an artificial neural network (ANN) such as the guided diffusion model described with reference to FIG. 8 and the U-Net described with reference to FIG. 9. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of image generation model 625 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

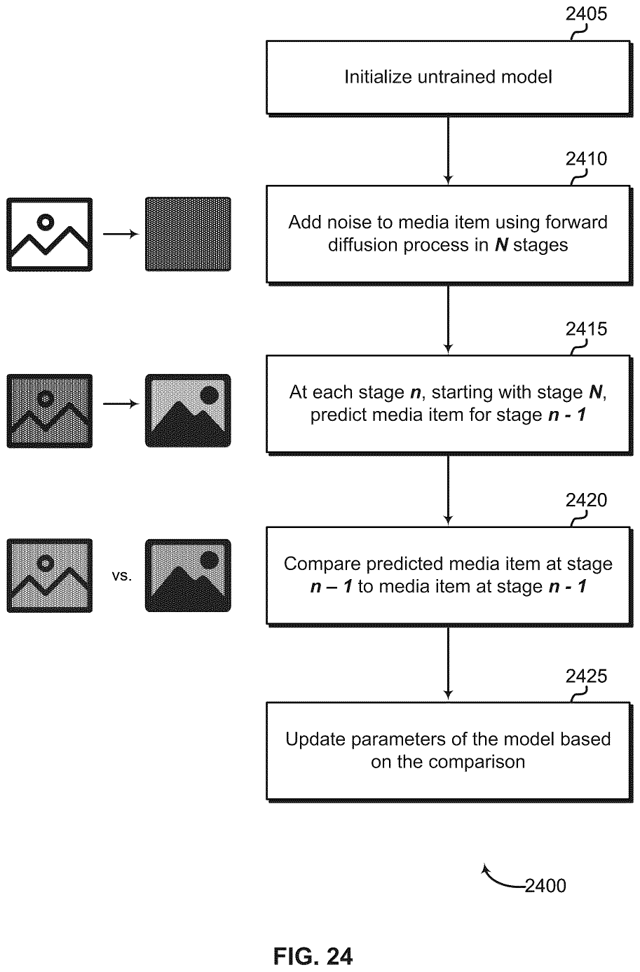

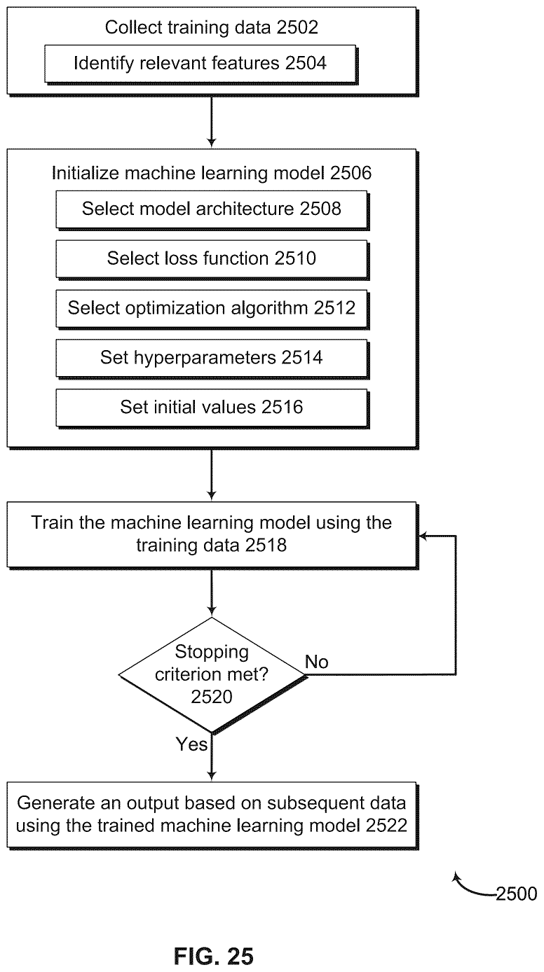

Training component 650 may train the image generation model 625. For example, parameters of the image generation model 625 can be learned or estimated from training data and then used to make predictions or perform tasks based on learned patterns and relationships in the data. In some examples, the parameters are adjusted during the training process to minimize a loss function or maximize a performance metric (e.g., as described with reference to FIGS. 24-25). The goal of the training process may be to find optimal values for the parameters that allow the machine learning model to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the image generation model 625 can be used to make predictions on new, unseen data (i.e., during inference).

I/O module 610 receives inputs from and transmits outputs of the image processing apparatus 600 to other devices or users. For example, I/O module 610 receives inputs for the image generation model 625 and transmits outputs of the image generation model 625. According to some aspects, I/O module 610 is an example of the I/O interface 2620 described with reference to FIG. 26.

According to some aspects, image generation model 625 obtains an input image and a mask indicating a region of the input image. In some examples, image generation model 625 generates an intermediate image based on the input image and the mask, where the intermediate image differs from the input image within the region indicated by the mask and is similar to the input image outside of the region indicated by the mask. In some examples, image generation model 625 obtains a condition input indicating a transformation to a first content within the region indicated by the mask, where the intermediate image is generated based on the condition input, and where the intermediate image includes the transformation to the first content within the region indicated by the mask.

In some examples, image generation model 625 performs a first phase of a diffusion process based on the mask. Image generation model 625 performs a second phase of the diffusion process independent of the mask, where the first phase precedes the second phase. In some examples, image generation model 625 identifies a sampling interval parameter, where the first phase is based on the sampling interval parameter. In some examples, image generation model 625 skips one or more diffusion steps of the diffusion process based on the sampling interval parameter. In some examples, image generation model 625 identifies a masking interval parameter, where the first phase is based on the masking interval parameter. In some examples, the composite image includes a seamless transition between the content from the input image outside of the region indicated by the mask and the content from the intermediate image within the region indicated by the mask based on a similarity between them.

According to some embodiments, image generation model 625 obtains an input image and a mask indicating a region of the input image. In some examples, image generation model 625 performs, using image generation model 625, a first phase of a diffusion process based on the mask. Image generation model 625 performs, using image generation model 625, a second phase of the diffusion process independent of the mask. Image generation model 625 generates a synthetic image based on the first phase and the second phase, where the synthetic image includes a structural similarity to the input image. In some examples, the input image includes a vector image, and the synthetic image includes a detailed depiction of a scene of the vector image. In some examples, image generation model 625 obtains a text prompt indicating a style, where the synthetic image is generated based on the text prompt and includes the style.

In some examples, image generation model 625 performs a first phase of a diffusion process based on the mask and a second phase of the diffusion process independent of the mask. The first phase is based on a masking interval parameter and a sampling interval parameter.

In one embodiment, image generation model 625 includes image segmentation model 630, diffusion model 635, control network 640, and stitching component 645. Image segmentation model 630 segments the input image to obtain a set of masked regions.

According to some embodiments, control network 640 extracts structural information from the input image, where the structural information is provided as input to image generation model 625, and where the intermediate image has a same structure as the input image outside of the region indicated by the mask based on the structural information. In some examples, the structural information is based on the mask.

According to some embodiments, stitching component 645 combines the input image and the intermediate image to obtain a composite image, where the composite image includes content from the intermediate image within the region indicated by the mask and content from the input image outside of the region indicated by the mask. In some examples, stitching component 645 produces a first masked image based on the mask and the input image, where the first masked image includes the content from the input image outside of the region indicated by the mask. Stitching component 645 produces a second masked image based on the mask and the intermediate image, where the second masked image includes the content from the intermediate image within the region indicated by the mask. Stitching component 645 combines the first masked image and the second masked image to obtain the composite image.

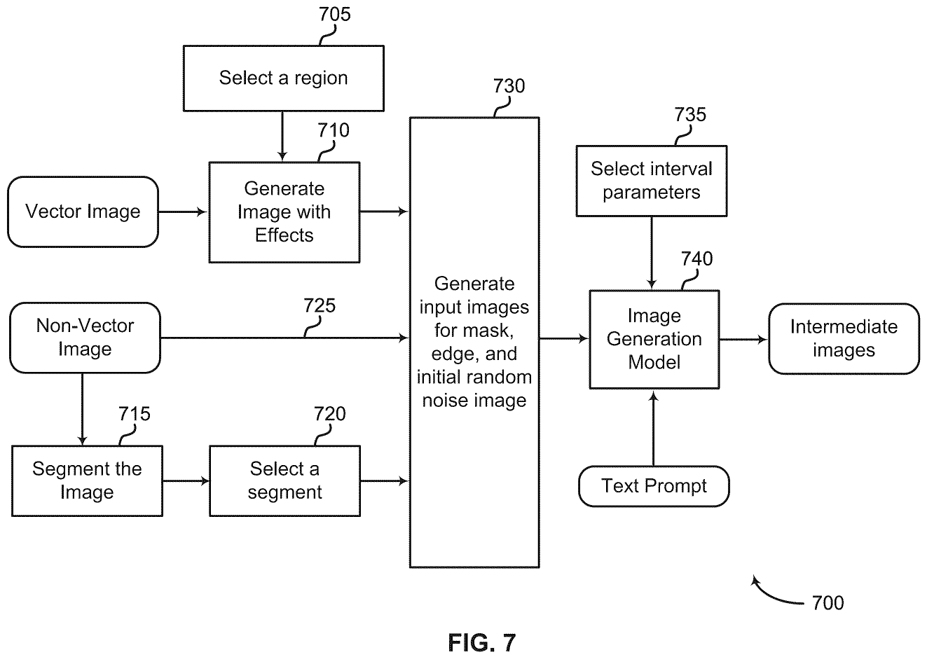

FIG. 7 shows an example of a method of operating a machine learning model 700 according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 705, a user selects a region. In some cases, the region is a segment within an input image. The input image includes one or more segments selectable by the user (e.g., clicking on a segment). In some cases, the operations of this step refer to, or may be performed by, a user interface as described with reference to FIG. 6.

At operation 710, the system generates image with effect based on a vector image selected by the user. In some cases, a vector image is made of mathematical paths and mathematical shapes such as lines, points, curves, polygons, etc. The vector image may be of a file format such as scalable vector graphic (“SVG”) or encapsulated postscript (“EPS”). In some cases, the user provides a text prompt such as “an airport with view of an aero plane taking off” and the text prompt is fed to a diffusion model for image generation.

At operation 715, the system segments an input image (e.g., a non-vector image) to a set of segments (or masked segments) using an image segmentation model. In some cases, the non-vector image is also known as a raster image or a realistic image. Subsequent operations apply an effect to a segment from the set of segments (or masked segments).

At operation 720, the user selects a segment from the set of segments and wants to apply effect to the selected segment. In some cases, the operations of this step refer to, or may be performed by, a user interface as described with reference to FIG. 6.

At operation 725, the system passes the entire image as initial image for broader context. At operation 730, the system obtains a mask, an edge image, and an initial random noise image. In some cases, a mask in image segmentation is a binary or multi-class map where each pixel is labeled as belonging to a certain class (e.g., foreground vs. background). The mask may be used to indicate a region of the input image such that effect or change may be applied within the region indicated by the mask. In some cases, a region of the input image indicated by the mask has a regular shape or an irregular shape, e.g., an irregular shape corresponding to a t-shirt. The edge image includes a set of edges indicating the structure of the input image.

At operation 735, the system receives a sampling interval parameter and a masking interval parameter. The sampling interval parameter is set by the user. In some examples, the sampling interval parameter is set to 0.3, i.e., 30% of initial generation process are to be skipped and the model will start image generation from this point with the input image as base. The masking interval parameter is set to [0, 0.85]. This ensures that the model generates effect within the masked region for 85% of the time steps. In some cases, the operations of this step refer to, or may be performed by, a user interface as described with reference to FIG. 6.

At operation 740, the system generates an intermediate image based on the sampling interval parameter, the masking interval parameter, the target segment, and a text prompt. In some cases, the operations of this step refer to, or may be performed by, a diffusion model as described with reference to FIG. 6.

FIG. 8 shows an example of a guided diffusion model according to aspects of the present disclosure. The guided latent diffusion model 800 depicted in FIG. 8 is an example of, or includes aspects of, the corresponding element (i.e., diffusion model 635) described with reference to FIG. 6.

Diffusion models are a class of generative neural networks which can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image itself, or to image features generated by an encoder (i.e., latent diffusion).

Diffusion models work by iteratively adding noise to the data during a forward process and then learning to recover the data by denoising the data during a reverse process. For example, during training, guided latent diffusion model 800 may take an original image 805 in a pixel space 810 as input and apply and image encoder 815 to convert original image 805 into original image features 820 in a latent space 825. Then, a forward diffusion process 830 gradually adds noise to the original image features 820 to obtain noisy features 835 (also in latent space 825) at various noise levels.

Next, a reverse diffusion process 840 (e.g., a U-Net ANN) gradually removes the noise from the noisy features 835 at the various noise levels to obtain denoised image features 845 in latent space 825. In some examples, the denoised image features 845 are compared to the original image features 820 at each of the various noise levels, and parameters of the reverse diffusion process 840 of the diffusion model are updated based on the comparison. Finally, an image decoder 850 decodes the denoised image features 845 to obtain an output image 855 in pixel space 810. In some cases, an output image 855 is created at each of the various noise levels. The output image 855 can be compared to the original image 805 to train the reverse diffusion process 840.

In some cases, image encoder 815 and image decoder 850 are pre-trained prior to training the reverse diffusion process 840. In some examples, image encoder 815 and image decoder 850 are trained jointly, or the image encoder 815 and image decoder 850 and fine-tuned jointly with the reverse diffusion process 840.

The reverse diffusion process 840 can also be guided based on a text prompt 860, or another guidance prompt, such as an image, a layout, a segmentation map, etc. The text prompt 860 can be encoded using a text encoder 865 (e.g., a multimodal encoder) to obtain guidance features 870 in guidance space 875. The guidance features 870 can be combined with the noisy features 835 at one or more layers of the reverse diffusion process 840 to ensure that the output image 855 includes content described by the text prompt 860. For example, guidance features 870 can be combined with the noisy features 835 using a cross-attention block within the reverse diffusion process 840.

FIG. 9 shows an example of a U-Net 900 architecture according to aspects of the present disclosure. In some examples, U-Net 900 is an example of the component that performs the reverse diffusion process 840 of guided latent diffusion model 800 described with reference to FIG. 8 and includes architectural elements of the image generation model 625 described with reference to FIG. 6. The U-Net 900 depicted in FIG. 9 is an example of, or includes aspects of, the architecture used within the reverse diffusion process described with reference to FIG. 8.

In some examples, diffusion models are based on a neural network architecture known as a U-Net. The U-Net 900 takes input features 905 having an initial resolution and an initial number of channels and processes the input features 905 using an initial neural network layer 910 (e.g., a convolutional network layer) to produce intermediate features 915. The intermediate features 915 are then down-sampled using a down-sampling layer 920 such that down-sampled features 925 have a resolution less than the initial resolution and a number of channels greater than the initial number of channels.

This process is repeated multiple times, and then the process is reversed. That is, the down-sampled features 925 are up-sampled using up-sampling process 930 to obtain up-sampled features 935. The up-sampled features 935 can be combined with intermediate features 915 having the same resolution and number of channels via a skip connection 940. These inputs are processed using a final neural network layer 945 to produce output features 950. In some cases, the output features 950 have the same resolution as the initial resolution and the same number of channels as the initial number of channels.

In some cases, U-Net 900 takes additional input features to produce conditionally generated output. For example, the additional input features could include a vector representation of an input prompt. The additional input features can be combined with the intermediate features 915 within the neural network at one or more layers. For example, a cross-attention module can be used to combine the additional input features and the intermediate features 915.

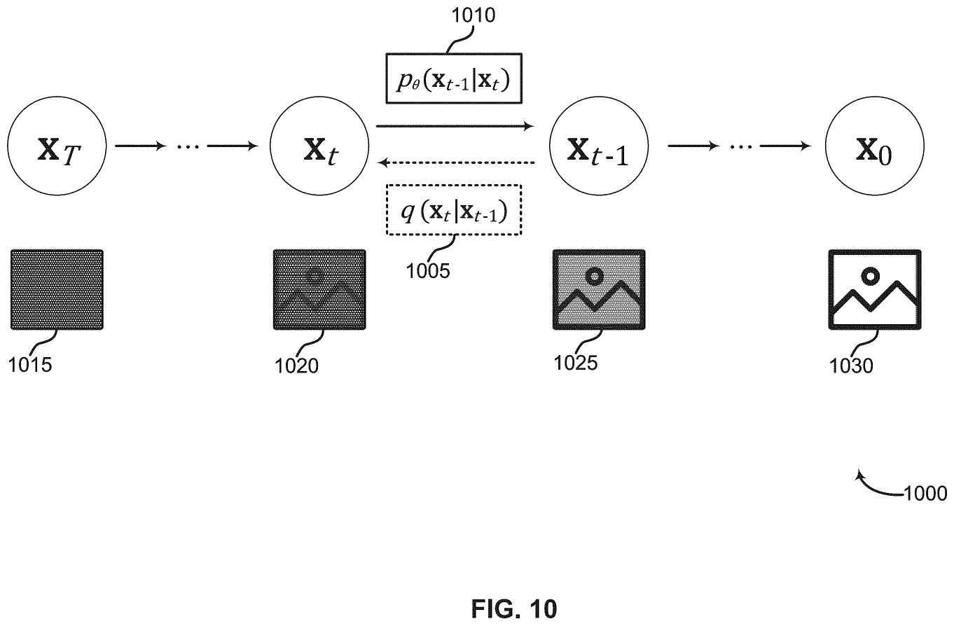

FIG. 10 shows an example of a diffusion process 1000 according to aspects of the present disclosure. In some examples, diffusion process 1000 describes an operation of the diffusion model 635 described with reference to FIG. 6, such as the reverse diffusion process 840 of guided latent diffusion model 800 described with reference to FIG. 8.

As described above with reference to FIG. 8, using a diffusion model can involve both a forward diffusion process 1005 for adding noise to a media item (or features in a latent space) and a reverse diffusion process 1010 for denoising the media item (or features) to obtain a denoised media item. The forward diffusion process 1005 can be represented as q(xₜ|xₜ₋₁), and the reverse diffusion process 1010 can be represented as p(xₜ₋₁|xₜ). In some cases, the forward diffusion process 1005 is used during training to generate media items with successively greater noise, and a neural network is trained to perform the reverse diffusion process 1010 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 1010, the model begins with noisy data x, such as a noisy media item 1015 and denoises the data to obtain the p(xₜ₋₁| xₜ). At each step t−1, the reverse diffusion process 1010 takes xₜ, such as first intermediate media item 1020, and t as input. Here, t represents a step in the sequence of transitions associated with different noise levels, The reverse diffusion process 1010 outputs xₜ₋₁, such as second intermediate media item 1025 iteratively until x-reverts back to x₀, the original media item 1030. The reverse process can be represented as:

$$\\ \begin{matrix}{p}_{θ} ( {x}_{t - 1} \vert {x}_{t} ) := N ( {x}_{t - 1} ; {μ}_{θ} ( {x}_{t} , t ) , {\sum }_{θ} ( {x}_{t} , t ) ) . & ( 1 )\end{matrix}$$

The joint probability of a sequence of samples in the Markov chain can be written as a product of conditionals and the marginal probability:

$$\\ \begin{matrix}{x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) , & ( 2 )\end{matrix}$$

where p(x_{T})=N(x_{T};0,I) is the pure noise distribution as the reverse process takes the outcome of the forward process, a sample of pure noise, as input and

$$\\ {\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At inference time, observed data x₀ in a pixel space can be mapped into a latent space as input and a generated data \tilde{x} is mapped back into the pixel space from the latent space as output. In some examples, x₀ represents an original input media item with low quality, latent variables x₁, . . . , x_{T} represent noisy media items, and \tilde{x} represents the generated item with high quality.

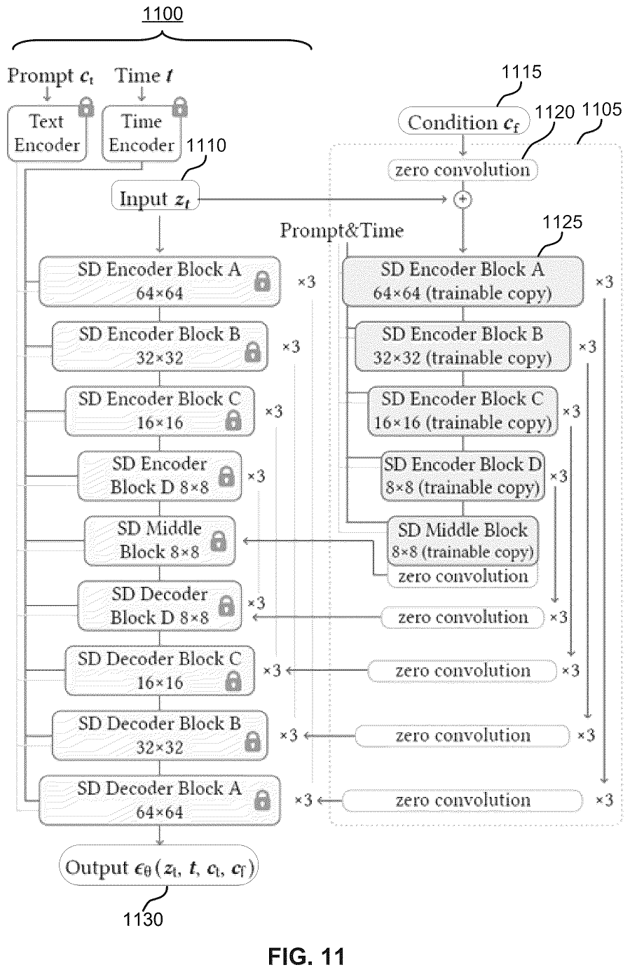

FIG. 11 shows an example of an image generation model comprising a control network according to aspects of the present disclosure. The example shown includes U-Net 1100, control network 1105, noisy image 1110, conditioning vector 1115, zero convolution layer 1120, trainable copy 1125, and learned network 1130.

ControlNet is a neural network structure configured to control image generation models by adding extra conditions. In some embodiments, a ControlNet architecture copies the weights from some of the neural network blocks of the image generation model to create a “locked” copy and a “trainable” copy 1125. The “trainable” one learns your condition. The “locked” copy preserves the parameters of the original model. The trainable copy 1125 can be tuned with a small dataset of image pairs, while preserving the locked copy ensures that original model is preserved.

As an example architecture shown in FIG. 11, the image generation model comprises U-Net 1100 (the left-hand side) and control network 1105 (the right-hand side). In some embodiments, a ControlNet architecture can be used to control a diffusion U-Net 1100 (i.e., to add controllable parameters or inputs that influence the output). Encoder layers of the U-Net 1100 can be copied and tuned. Then zero convolution layers can be added. The output of the control network 1105 can be input to decoder layers of the U-Net 1100.

In an embodiment, Stable Diffusion's U-Net is connected with a ControlNet on the encoder blocks and middle block. The locked blocks (light gray) show the structure of Stable Diffusion (U-Net architecture). The trainable copy blocks (dark gray) and the zero convolution layers are added to build a ControlNet. In some cases, trainable copy 1125 may be referred to as a trainable copy block or a trainable block.

In some embodiments, one or more zero convolution layers (e.g., zero convolution layer 1120) are added to the trainable copy 1125. A zero convolution layer 1120 is 1×1 convolution with both weight and bias initialized as zeros. Before training, the zero convolution layers output all zeros. Accordingly, the ControlNet does not cause any distortion. As the training proceeds, the parameters of the zero convolution layers deviate from zero and the influence of the ControlNet on the output grows.

Given an input image z₀, image diffusion algorithms progressively add noise to the image and produce a noisy image zₜ, where t represents the number of times noise is added. Given a set of conditions including time step t, text prompts cₜ, as well as a task-specific condition c_{f}, image diffusion algorithms learn a network ∈_{θ} to predict the noise added to the noisy image zₜ with:

$$\\ \begin{matrix}L = {E}_{{z}_{0} , t , {c}_{t} , {c}_{f} , ϵ \sim N ( 0 , 1 )} [ {‖ ϵ - ϵ ( {z}_{t} , t , {c}_{t} , {c}_{f} ) ‖}_{2}^{2} ] & ( 3 )\end{matrix}$$

where L is the overall learning objective of the entire diffusion model. This learning objective is directly used in fine-tuning diffusion models with ControlNet. The output from U-Net 1100 includes parameters corresponding to learned network 1130, e.g., output ∈_{θ}(xₜ, t, cₜ, c_{f}).

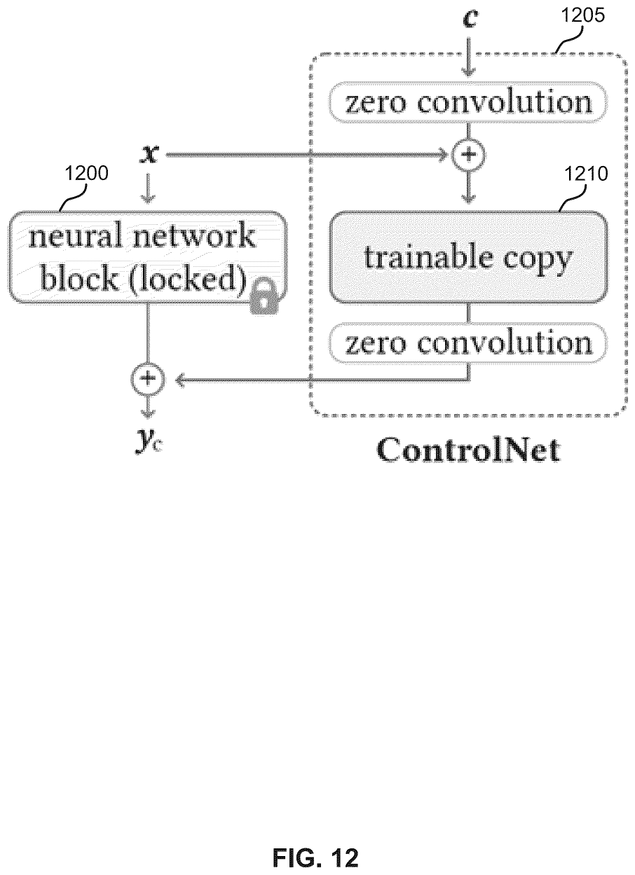

Control network 1105 is an example of, or includes aspects of, the corresponding element described with reference to FIGS. 6-7 and 12. Trainable copy 1125 is an example of, or includes aspects of, the corresponding element described with reference to FIG. 12.

FIG. 12 shows an example of a control network 1205 of an image generation model according to aspects of the present disclosure. The example shown includes neural network block 1200, control network 1205, and trainable copy 1210.

In some examples, a neural network block 1200 takes a feature map x as input and outputs another feature map y. To add a ControlNet (i.e., control network 1205) to such a block, some embodiments lock the original block and create a trainable copy 1210 and connect them together using zero convolution layers, i.e., 1× 1 convolution with both weight and bias initialized to zero. Here c is a conditioning vector added to the network.

In an embodiment, Stable Diffusion's U-Net is connected with a ControlNet on the encoder blocks and middle block. The locked neural network block 1200 (light gray) shows a portion of the structure of Stable Diffusion (U-Net architecture). The trainable copy 1210 (dark gray) and the zero convolution layers are added to build a ControlNet. In some cases, trainable copy 1210 may be referred to as a trainable copy block or a trainable block.

Control network 1205 is an example of, or includes aspects of, the corresponding element described with reference to FIGS. 6-7 and 11. Trainable copy 1210 is an example of, or includes aspects of, the corresponding element described with reference to FIG. 11.

In FIGS. 6-12, an apparatus, system, and method for image processing are described. One or more embodiments of the apparatus, system, and method include a memory component; a processing device coupled to the memory component, the processing device configured to perform operations comprising: obtaining an input image and a mask indicating a region of the input image; generating, using an image generation model, an intermediate image based on the input image and the mask, wherein the intermediate image differs from the input image within the region indicated by the mask and is similar to the input image outside of the region indicated by the mask; and combining the input image and the intermediate image to obtain a composite image, wherein the composite image includes content from the intermediate image within the region indicated by the mask and content from the input image outside of the region indicated by the mask.

In some examples, the image generation model performs a first phase of a diffusion process based on the mask and a second phase of the diffusion process independent of the mask. In some examples, the first phase is based on a masking interval parameter and a sampling interval parameter.

In some examples, the image generation model comprises a control network configured to extract structural information from the input image, and wherein the structural information is provided as input to the image generation model.

Some examples of the apparatus, system, and method further include an image segmentation model configured to segment the input image to obtain a plurality of masked regions.

### Image Composition via Intermediate Image

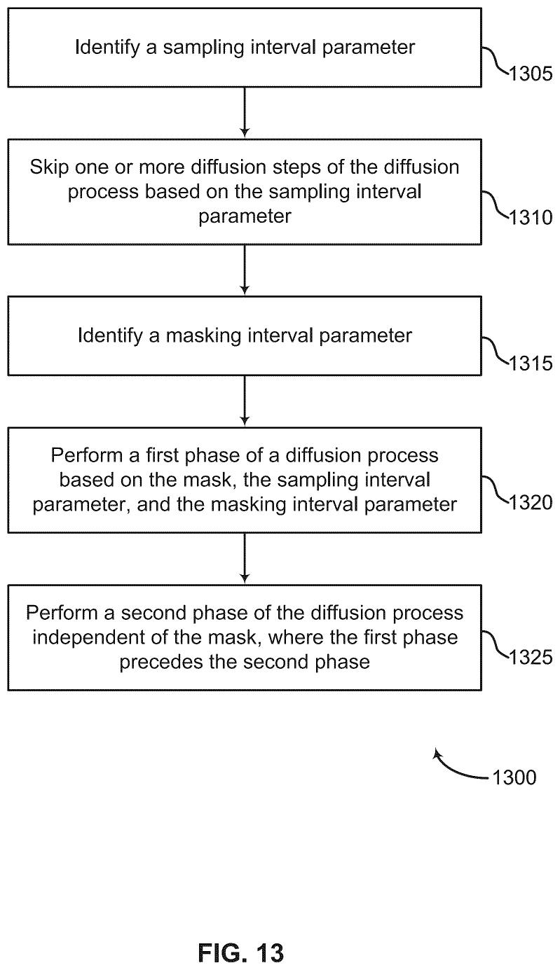

FIG. 13 shows an example of a method 1300 for image processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 1305, the system identifies a sampling interval parameter. In some cases, the operations of this step refer to, or may be performed by, an image generation model as described with reference to FIG. 6. In some cases, the sampling interval parameter is set to be a real number between 0 and 1. For example, the sampling interval parameter is set to 0.15 such that 15% of initial diffusion time steps are to be skipped and the model with start image generation from this point (right after 15%) with the input image as base.

At operation 1310, the system skips one or more diffusion steps of the diffusion process based on the sampling interval parameter. The sampling interval parameter indicates a number of skipped diffusion steps. In some cases, if a total number of time steps in a diffusion process is 50 steps and the sampling interval parameter is 0.3, then an initial 50×0.3=15 steps are skipped. In some cases, the operations of this step refer to, or may be performed by, an image generation model as described with reference to FIG. 6.

At operation 1315, the system identifies a masking interval parameter. In some cases, the masking interval parameter is set to be a range between 0 and 1, or a subinterval of [0, 1]. In some cases, the operations of this step refer to, or may be performed by, an image generation model as described with reference to FIG. 6.

At operation 1320, the system performs a first phase of a diffusion process based on the mask, the sampling interval parameter, and the masking interval parameter. In some cases, the first phase refers to an initial number of time steps in the diffusion process prior to performing a second phase. In some cases, if a total number of time steps in a diffusion process is 50 and the sampling interval parameter is 0.3, then an initial 50×0.3=15 steps are skipped. Additionally, the masking interval parameter is 0.6, accordingly the first phase includes steps from 16 to 30 (50×0.6=30). The sampling interval parameter and the masking interval parameters may be set to other values or intervals. The time steps of the first phase and the second phase will adjust in accord with the parameters. In some cases, the operations of this step refer to, or may be performed by, an image generation model as described with reference to FIG. 6.

At operation 1325, the system performs a second phase of the diffusion process independent of the mask, where the first phase precedes the second phase. In some cases, the operations of this step refer to, or may be performed by, an image generation model as described with reference to FIG. 6.

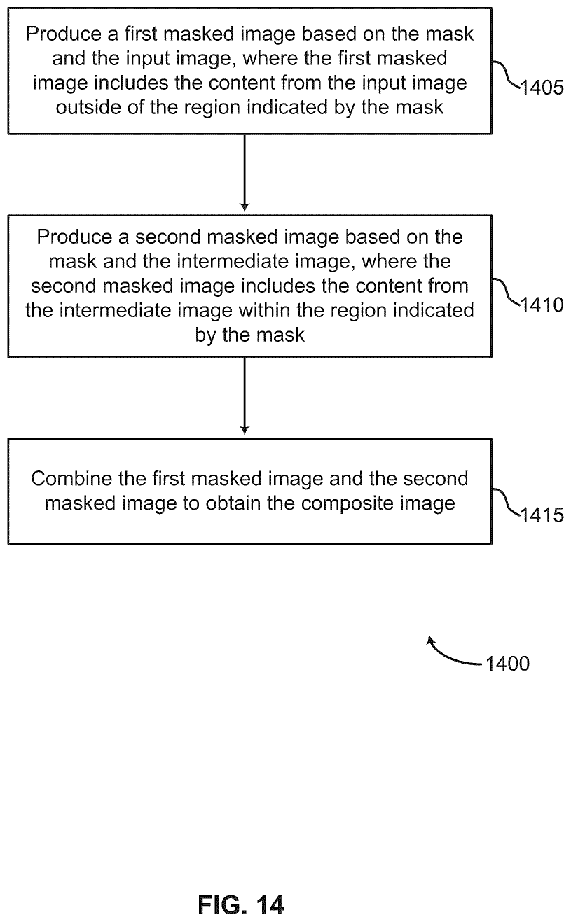

FIG. 14 shows an example of a method 1400 for generating a composite image according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 1405, the system produces a first masked image based on the mask and the input image, where the first masked image includes the content from the input image outside of the region indicated by the mask. In some cases, the input image depicts a man with a t-shirt standing in front of a car in a street. The mask includes white-pixel area corresponding to regions other than the t-shirt region. The first masked image includes the content from the input image outside of the t-shirt region, such as rest of the man not covered by the t-shirt car, and street (i.e., background scene). In some cases, the operations of this step refer to, or may be performed by, a stitching component as described with reference to FIG. 6. In some cases, the first masked image is an example of, or refers to, or includes aspects of, first masked image 1725 of FIG. 17.

At operation 1410, the system produces a second masked image based on the mask and the intermediate image, where the second masked image includes the content from the intermediate image within the region indicated by the mask. In some cases, the mask includes a white-pixel area corresponding to the t-shirt region, the second masked image includes the content from the intermediate image in the t-shirt region. In some cases, the operations of this step refer to, or may be performed by, a stitching component as described with reference to FIG. 6. In some cases, the second masked image is an example of, or refers to, or includes aspects of, the second masked image 1710 of FIG. 17.

At operation 1415, the system combines the first masked image and the second masked image to obtain the composite image. In some cases, the combined image includes content from the input image outside the region indicated by the mask and content from the intermediate image in the region indicated by the mask. In some cases, the operations of this step refer to, or may be performed by, a stitching component as described with reference to FIG. 6.

FIG. 15 shows an example of applying effect to a segment of an input image 1500 according to aspects of the present disclosure. The example shown includes input image 1500, first segment 1505, edited input image 1510, and second segment 1515. Input image 1500 is an example of, or includes aspects of, the corresponding element described with reference to FIGS. 3 and 17.

As an example shown in FIG. 15, a user applies effect to a segment of input image 1500. The user clicks input image 1500 and starts editing the image. An image segmentation model described with reference to FIG. 6 (e.g., FB Segment Anything Model, SAM) may be used to segment the input image 1500 to obtain a set of masked regions (e.g., first segment 1505, second segment 1515). The user selects second segment 1515 within input image 1500, which is a target region to apply the effect. After selecting second segment 1515, a shading/highlighting effect indicating the second segment 1515 appear in edited input image 1510. The user provides the effect she/he wants to apply, e.g., “A t-shirt made of tiger fur”.

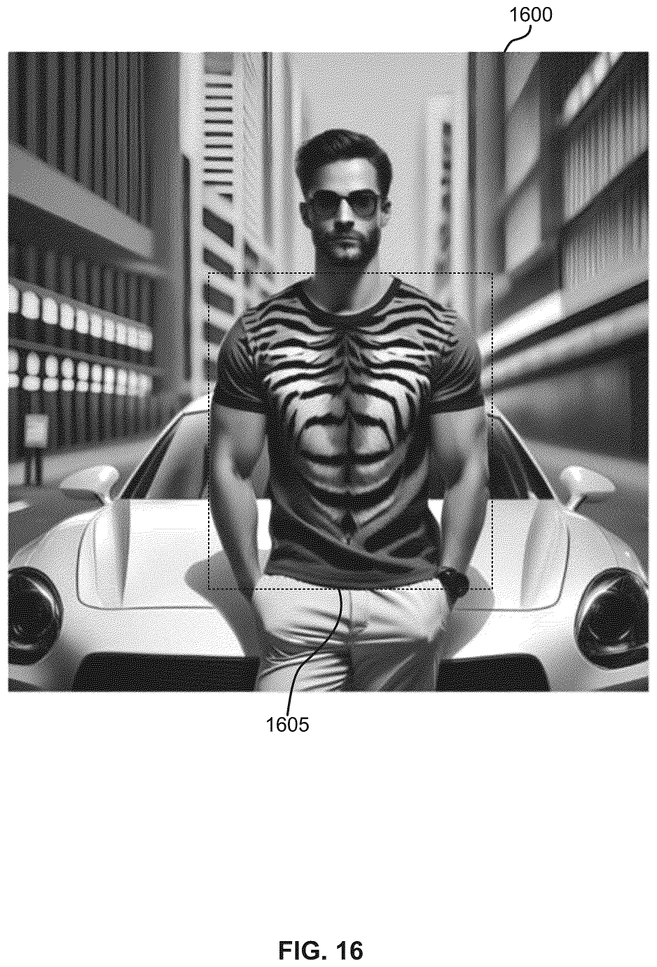

FIG. 16 shows an example of an intermediate image 1600 according to aspects of the present disclosure. The example shown includes intermediate image 1600 and target region 1605. Intermediate image 1600 is an example of, or includes aspects of, the corresponding element described with reference to FIG. 17.

In some embodiments, image generation model 625 described with reference to FIG. 6 creates effects on a segmented area (e.g., target region 1605). Image generation model 625 applies diffusion related techniques such as SDEdit, DiffEdit, and structure match to create effects in such a way that it can be seamlessly stitched back into input image 1500. For DiffEdit, image generation model 625 uses the segmented region (selected by the user) as the masked image. A masking interval parameter is set to [0, 0.85]. The masking interval parameter ensures that image generation model 625 generates effect within the masked region for 85% of the time steps.

For SDEdit, image generation model 625 uses the entire image as the initial image. This ensures that the area outside the masked region remains the same as the input image 1500 during the time when DiffEdit is being performed. This ensures that stitching the effect back into the original image is seamless and natural. Additionally, the effect is adjustable by users, i.e., can be more creative or stay closer to the original image. If image generation model 625 receives a low sampling interval, then the model creates an effect which is more creative and distinct from the original image. If the user wants the output to be closer to the original image and less creative, image generation model 625 receives an increased sampling interval. This setting is exposed to the user as a creativity slider. If the original content has some lighting, shadows, and/or colors, these types of information are preserved more as the sampling interval is increased.

In an embodiment, the original image is used as structure match (canny data) so that edges in original image are preserved. This way, the generated segment has the same folds and curves as the original segment. After performing the above steps, image generation model 625 generates an intermediate image 1600 (also referred to as intermediate output). The intermediate image 1600 contains the desired effect in the masked region. The area outside the masked region resembles the original image closely, therefore ensuring high stitching performance as described in FIG. 17.

FIG. 17 shows an example of combining an input image 1715 and an intermediate image 1700 according to aspects of the present disclosure. The example shown includes intermediate image 1700, first mask 1705, first masked image 1710, input image 1715, second mask 1720, second masked image 1725, and composite image 1730.

In some embodiments, stitching component 645 receives the intermediate image 1700 to perform a stitching operation. Stitching component 645 uses the mask image and replaces the pixels of (original) input image 1715 corresponding to the white regions of the mask with the pixels in the intermediate image 1700. Stitching component 645 applies pixels from intermediate image 1700 back into (original) input image 1715 such that the intermediate image 1700 is substantial similar to the input image 1715 in non-masked region. Composite image 1730 is the output after stitching intermediate image 1700 and input image 1715.

Intermediate image 1700 is an example of, or includes aspects of, the corresponding element described with reference to FIG. 16. Input image 1715 is an example of, or includes aspects of, the corresponding element described with reference to FIGS. 3 and 15.

FIG. 18 shows an example of composite images by changing a sampling interval parameter according to aspects of the present disclosure. The example shown includes first composite image 1800, second composite image 1805, third composite image 1810, and fourth composite image 1815. In some examples, as the sampling interval increases from left to right, creativity decreases and adherence to original image increases. First composite image 1800 is an example of, or includes aspects of, the corresponding element described with reference to FIG. 3. Second composite image 1805 is an example of, or includes aspects of, the corresponding element described with reference to FIG. 3.

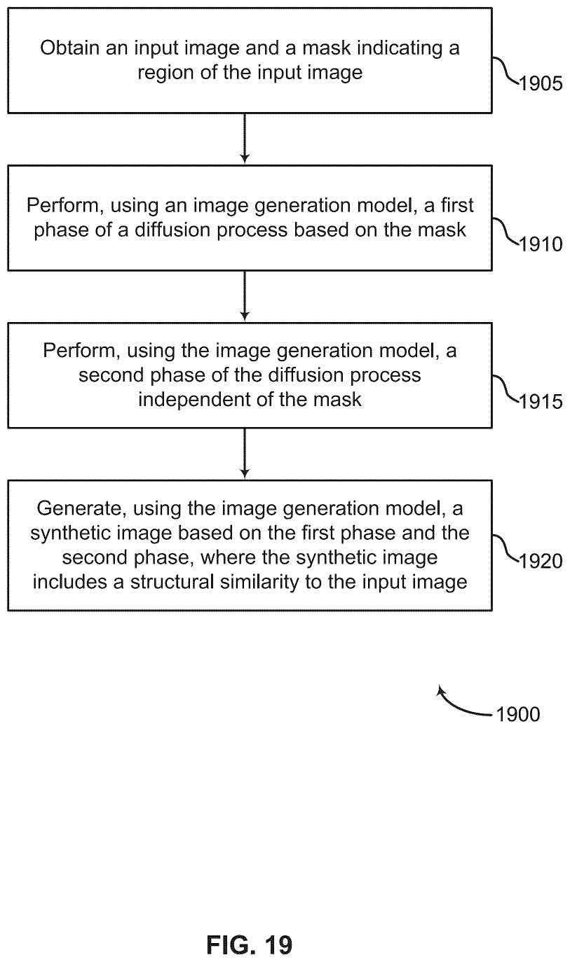

FIG. 19 shows an example of a method 1900 for image processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1905, the system obtains an input image and a mask indicating a region of the input image. In some cases, the operations of this step refer to, or may be performed by, an image generation model as described with reference to FIG. 6.

At operation 1910, the system performs, using an image generation model, a first phase of a diffusion process based on the mask. In some cases, the first phase begins right after one or more time steps of a diffusion process are skipped. In some cases, the operations of this step refer to, or may be performed by, an image generation model as described with reference to FIG. 6.

At operation 1915, the system performs, using the image generation model, a second phase of the diffusion process independent of the mask. In some cases, the first phase precedes the second phase. In some cases, the operations of this step refer to, or may be performed by, an image generation model as described with reference to FIG. 6.

At operation 1920, the system generates, using the image generation model, a synthetic image based on the first phase and the second phase, where the synthetic image includes a structural similarity to the input image. In some cases, the operations of this step refer to, or may be performed by, an image generation model as described with reference to FIG. 6.

### Vector to Realistic Image Synthesis

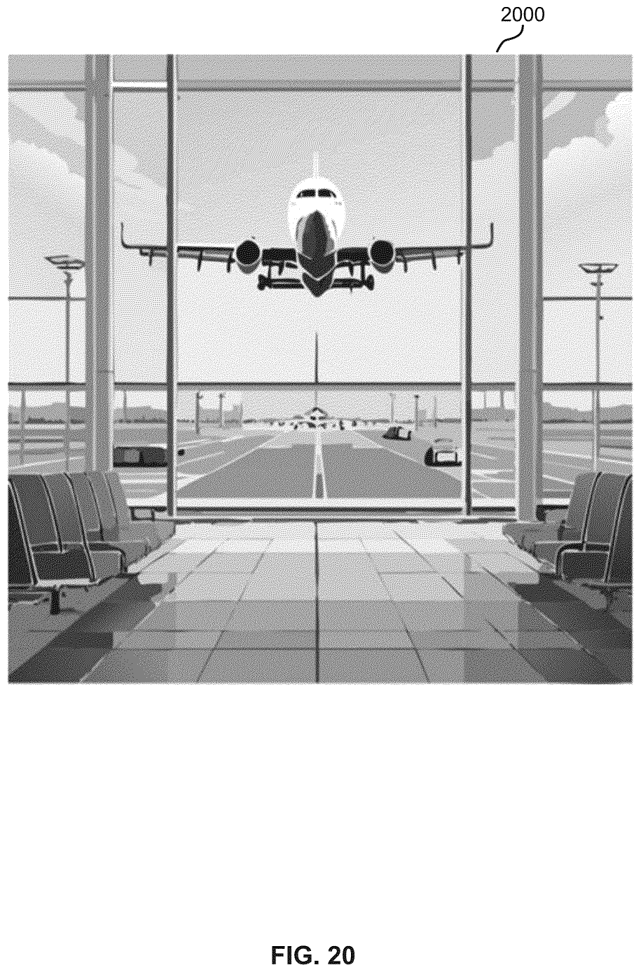

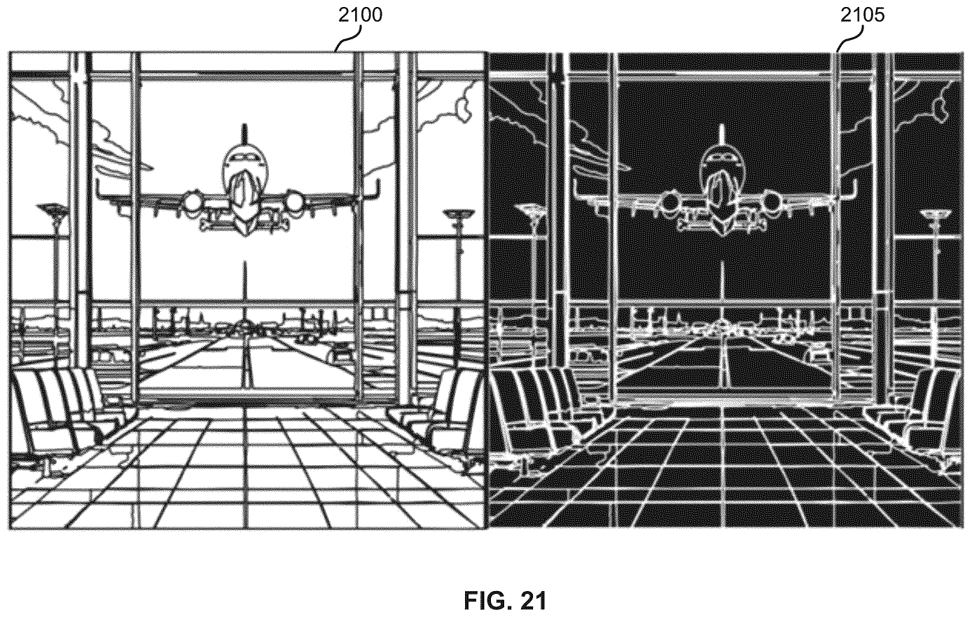

FIG. 20 shows an example of a vector image 2000 as input according to aspects of the present disclosure. FIG. 21 shows an example of a mask 2100 and an edge image 2105 according to aspects of the present disclosure. The example shown includes mask 2100 and edge image 2105. Referring to FIGS. 20-21, a user selects vector image 2000 and wants to create a realistic image based on vector image 2000. The user describes the illustration, e.g., “An airport with view of an aeroplane taking off”.

In some embodiments, image generation model 625 removes all the styles, fill and stroke properties applied to the vector image 2000. Then, image generation model 625 fills all the closed paths within the SVG with white color, while image generation model 625 fills the strokes with black color. This is a mask image (i.e., mask 2100) to be used by DiffEdit. Image generation model 625 inverts the colors of mask 2100 to generate an edge image 2105.

Image generation model 625 then generates a realistic (synthetic) image using diffusion techniques such as SDEdit, DiffEdit, and structure match in the following. For DiffEdit, image generation model 625 uses the mask image created above (i.e., mask 2100). The masking interval is set to [0, 0.55]. Image generation model 625 receives a high masking interval so that the original illustration is faithfully recreated as a realistic image. For SDEdit, the original image is used as the initial image. Image generation model 625 receives a low sampling interval of 0.15, which ensures that the model starts using the original image as the starting point and adds realistic effect to it.

In some examples, the edge image 2105 is used as structure match data (canny data) so that the edges in the original illustration are preserved. The above steps lead to faithfully recreating the illustration as a realistic image. The use of SDEdit and DiffEdit along with structure match results in stronger adherence to edges and increased control over the output.

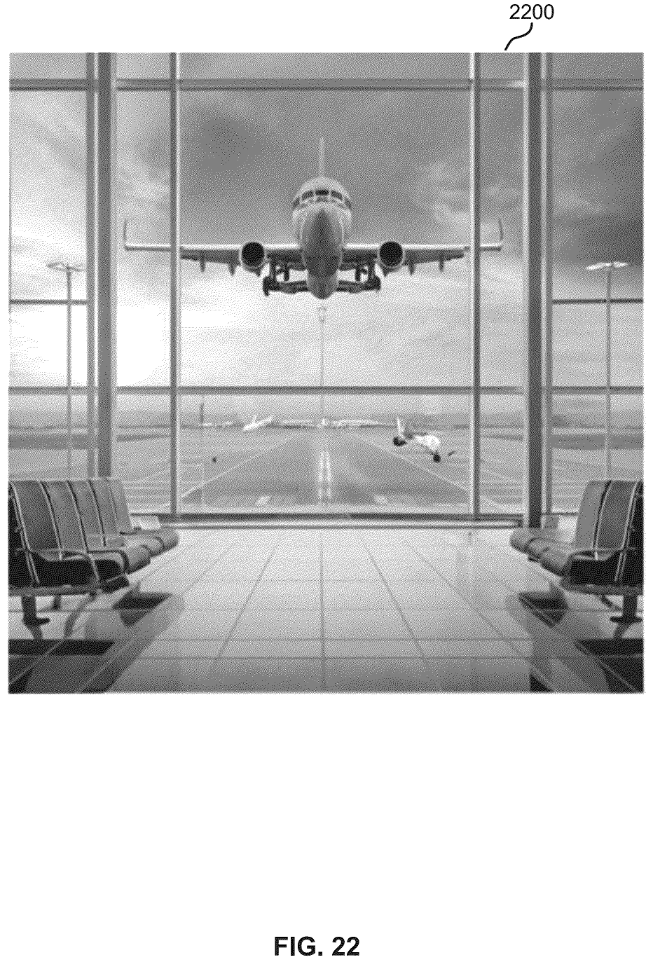

FIG. 22 shows an example of a realistic image according to aspects of the present disclosure. The example shown includes synthetic image 2200. The synthetic image 2200 comprises a detailed depiction of a scene of the vector image 2000.

FIG. 23 shows an example of synthetic images by changing a sampling interval parameter according to aspects of the present disclosure. The example shown includes first synthetic image 2300, second synthetic image 2305, third synthetic image 2310, and fourth synthetic image 2315. In some examples, as the sampling interval is increased, color scheme begins matching original illustration, and there is a tradeoff with details.

First synthetic image 2300 is an example of, or includes aspects of, the corresponding element described with reference to FIG. 4. Second synthetic image 2305 is an example of, or includes aspects of, the corresponding element described with reference to FIG. 4.

In FIGS. 13-23, a method, apparatus, non-transitory computer readable medium, and system for image processing are described. One or more embodiments of the method, apparatus, non-transitory computer readable medium, and system include obtaining an input image and a mask indicating a region of the input image; performing, using an image generation model, a first phase of a diffusion process based on the mask; performing, using the image generation model, a second phase of the diffusion process independent of the mask; and generating, using the image generation model, a synthetic image based on the first phase and the second phase, wherein the synthetic image comprises a structural similarity to the input image.

In some examples, the input image comprises a vector image and the synthetic image comprises a detailed depiction of a scene of the vector image.

Some examples of the method, apparatus, non-transitory computer readable medium, and system further include extracting structural information from the input image, wherein the structural information is provided as input to the image generation model. In some examples, the structural information is based on the mask.

Some examples of the method, apparatus, non-transitory computer readable medium, and system further include obtaining a text prompt indicating a style, wherein the synthetic image is generated based on the text prompt and includes the style.

FIG. 24 shows an example of a method 2400 for training a diffusion model according to aspects of the present disclosure. In some embodiments, the method 2400 describes an operation of the training component 650 described for configuring the image generation model 625 as described with reference to FIG. 6. The method 2400 represents an example for training a reverse diffusion process as described above with reference to FIGS. 8 and 10. In some examples, these operations are performed by a system including a processor executing a set of codes to control functional elements of an apparatus, such as the guided latent diffusion model described in FIG. 8.

Additionally or alternatively, certain processes of method 2400 may be performed using special-purpose hardware. Generally, these operations are performed according to the methods and processes described in accordance with aspects of the present disclosure. In some cases, the operations described herein are composed of various substeps or are performed in conjunction with other operations.

At operation 2405, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 2410, the system adds noise to a media item using a forward diffusion process in N stages. In some cases, the forward diffusion process is a fixed process where Gaussian noise is successively added to media item. In latent diffusion models, the Gaussian noise may be successively added to features in a latent space.

At operation 2415, starting with stage N, the system applies a reverse diffusion process to predict, at each stage n, the output or features at stage n−1. For example, the reverse diffusion process can predict the noise that was added by the forward diffusion process, and the predicted noise can be removed from the noise input to obtain the predicted output. In some cases, an original media item is predicted at each stage of the training process.

At operation 2420, the system compares predicted output (or features) at stage n−1 to an actual media item (or features), such as the output at stage n−1 or the original input. For example, given observed data x, the diffusion model may be trained to minimize the variational upper bound of the negative log-likelihood −log p_{θ}(x) of the training data.

At operation 2425, the system updates parameters of the model based on the comparison. For example, parameters of a U-Net may be updated using gradient descent. Time-dependent parameters of the Gaussian transitions can also be learned.

FIG. 25 shows an example of a step-by-step procedure for training a machine learning model according to aspects of the present disclosure. FIG. 25 shows a flow diagram depicting an algorithm as a step-by-step procedure 2500 in an example implementation of operations performable for training a machine-learning model. In some embodiments, the procedure 2500 describes an operation of the training component 650 described for configuring the image generation model 625 as described with reference to FIG. 6. The procedure 2500 provides one or more examples of generating training data, use of the training data to train a machine-learning model, and use of the trained machine-learning model to perform a task.

To begin in this example, a machine-learning system collects training data (block 2502) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 2504) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

To train the machine-learning model in the illustrated example, the machine-learning model is first initialized (block 2506). Initialization of the machine-learning model includes selecting a model architecture (block 2508) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 2510). The loss function is utilized to measure a difference between an output of the machine-learning model (i.e., predictions) and target values (e.g., as expressed by the training data) to be used to train the machine-learning model. Additionally, an optimization algorithm is selected (block 2512) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 2514) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 2518) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 2520), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 2520), the procedure 2500 continues training of the machine-learning model using the training data (block 2518) in this example.

If the stopping criterion is met (“yes” from decision block 2520), the trained machine-learning model is then utilized to generate an output based on subsequent data (block 2522). The trained machine-learning model, for instance, is trained to perform a task as described above and therefore, once trained, is configured to perform that task based on subsequent data received as an input and processed by the machine-learning model.

FIG. 26 shows an example of a computing device 2600 for image processing according to aspects of the present disclosure. The computing device 2600 may be an example of the image processing apparatus 600 described with reference to FIG. 6. In one aspect, computing device 2600 includes one or more processors 2605, memory subsystem 2610, communication interface 2615, I/O interface 2620, user interface component(s) 2625, and channel 2630.

In some embodiments, computing device 2600 is an example of, or includes aspects of, the image generation model of FIG. 6. In some embodiments, computing device 2600 includes one or more processors 2605 that can execute instructions stored in memory subsystem 2610 to perform media generation.

According to some aspects, computing device 2600 includes one or more processors 2605. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 2610 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 2615 operates at a boundary between communicating entities (such as computing device 2600, one or more user devices, a cloud, and one or more databases) and channel 2630 and can record and process communications. In some cases, communication interface 2615 is provided to enable a processing system coupled to a transceiver (e.g., a transmitter and/or a receiver). In some examples, the transceiver is configured to transmit (or send) and receive signals for a communications device via an antenna.

According to some aspects, I/O interface 2620 is controlled by an I/O controller to manage input and output signals for computing device 2600. In some cases, I/O interface 2620 manages peripherals not integrated into computing device 2600. In some cases, I/O interface 2620 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 2620 or via hardware components controlled by the I/O controller.

According to some aspects, user interface component(s) 2625 enable a user to interact with computing device 2600. In some cases, user interface component(s) 2625 include an audio device, such as an external speaker system, an external display device such as a display screen, an input device (e.g., a remote-control device interfaced with a user interface directly or through the I/O controller), or a combination thereof. In some cases, user interface component(s) 2625 include a GUI.

Performance of apparatus, systems and methods of the present disclosure have been evaluated, and results indicate embodiments of the present disclosure have obtained increased performance over conventional technology. Example experiments demonstrate that the image processing apparatus and the machine learning model described in embodiments of the present disclosure outperforms conventional systems.

The image generation model 625 described with reference to FIG. 6 can generate photorealistic effects on vector image and segmented image inputs in real-time, by using a latent diffusion model. Image generation model 625 outputs high quality results (e.g., highly detailed effects) by integrating edges masks and prompts. Image generation model 625 enables users to apply remarkable effects to vector shapes and strokes with unprecedented precision.

Compared to existing methods that often produce cutout-like effects, embodiments of the present disclosure provide far more realistic and intricate image results. For example, the details on the blazer with paisley effect look like someone meticulously handweave the details and preserve every curve and edge of the input blazer with high fidelity (refer to FIG. 3).

Image generation model 625 enables real-time generation of photorealistic effects for regions within an image and vector to image with effects, providing high-quality results without noticeable “cut-out” effects. Image generation model 625 enables control over the level of creativity in the output by modifying sampling interval, accordingly users have significant flexibility and power to tailor designs to their specific needs. Image generation model 625 provides real-time high-quality results and enables real-time generation of highly detailed images without loss of quality. Image generation model 625 provides transformative visual effects such that the model can transform even mundane vector graphics into stunning photorealistic images. Image generation model 625 generates high-resolution outputs up to 4K resolution using diffusion model, with easy regeneration of effects on updated vector inputs by preserving seed and prompt values.

In some embodiments, a latent diffusion model is used to generate realistic graphic effects. An image segmentation model segments an image in one click instead of user manually drawing the mask over image. A combination of SDEdit and DiffEdit methods are used to create effect in segmented area of an image and seamlessly stitch the effect back into an original image. Image generation model 625 can balance between creativity and adherence-to-original-shape by varying a sampling interval parameter in SDEdit and a masking interval parameter used in DiffEdit.

In some cases, a creativity slider and the ability to modify the level of detail through prompts provide users flexibility and control over the final output. Image generation model 625 can be seamlessly integrated into design tools and workflows, enhancing productivity and creativity for users. Image generation model 625 applies realistic effects to segments within an image to preserve original segment shape/objects aesthetic like folds or curves and generates effects with similar shape/objects. Additionally or alternatively, image generation model 625 generates a photorealistic image based on a vector image.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining an input image and a mask indicating a region of the input image;
generating, using an image generation model, an intermediate image based on the input image and the mask, wherein the intermediate image differs from the input image within the region indicated by the mask and is similar to the input image outside of the region indicated by the mask; and
combining the input image and the intermediate image to obtain a composite image, wherein the composite image includes content from the intermediate image within the region indicated by the mask and content from the input image outside of the region indicated by the mask.

2. The method of claim 1, further comprising:
obtaining a condition input indicating a transformation to a first content within the region indicated by the mask, wherein the intermediate image is generated based on the condition input, and wherein the intermediate image includes the transformation to the first content within the region indicated by the mask.

3. The method of claim 1, wherein obtaining the mask comprises:
segmenting the input image.

4. The method of claim 1, wherein generating the intermediate image comprises:
performing a first phase of a diffusion process based on the mask; and
performing a second phase of the diffusion process independent of the mask, wherein the first phase precedes the second phase.

5. The method of claim 4, further comprising:
identifying a sampling interval parameter, wherein the first phase is based on the sampling interval parameter.

6. The method of claim 5, further comprising:
skipping one or more diffusion steps of the diffusion process based on the sampling interval parameter.

7. The method of claim 4, further comprising:
identifying a masking interval parameter, wherein the first phase is based on the masking interval parameter.

8. The method of claim 1, wherein generating the intermediate image comprises:
extracting structural information from the input image, wherein the structural information is provided as input to the image generation model, and wherein the intermediate image has a same structure as the input image outside of the region indicated by the mask based on the structural information.

9. The method of claim 1, wherein combining the input image and the intermediate image comprises:
producing a first masked image based on the mask and the input image, wherein the first masked image includes the content from the input image outside of the region indicated by the mask;
producing a second masked image based on the mask and the intermediate image, wherein the second masked image includes the content from the intermediate image within the region indicated by the mask; and
combining the first masked image and the second masked image to obtain the composite image.

10. The method of claim 1, wherein:
the composite image comprises a seamless transition between the content from the input image outside of the region indicated by the mask and the content from the intermediate image within the region indicated by the mask based on a similarity between them.

11. A non-transitory computer readable medium storing code for image processing, the code comprising instructions that, when executed by at least one processor, cause the at least one processor to perform operations comprising:
obtaining an input image and a mask indicating a region of the input image;
performing, using an image generation model, a first phase of a diffusion process based on the mask;
performing, using the image generation model, a second phase of the diffusion process independent of the mask; and
generating, using the image generation model, a synthetic image based on the first phase and the second phase, wherein the synthetic image comprises a structural similarity to the input image.

12. The non-transitory computer readable medium of claim 11, the code further comprising instructions executable by the at least one processor to perform operations comprising:
the input image comprises a vector image and the synthetic image comprises a detailed depiction of a scene of the vector image.

13. The non-transitory computer readable medium of claim 11, the code further comprising instructions executable by the at least one processor to perform operations comprising:
extracting structural information from the input image, wherein the structural information is provided as input to the image generation model.

14. The non-transitory computer readable medium of claim 13, wherein:
the structural information is based on the mask.

15. The non-transitory computer readable medium of claim 11, the code further comprising instructions executable by the at least one processor to perform operations comprising:
obtaining a text prompt indicating a style, wherein the synthetic image is generated based on the text prompt and includes the style.

16. A system comprising:
a memory component; and
a processing device coupled to the memory component, the processing device configured to perform operations comprising:
obtaining an input image and a mask indicating a region of the input image;
generating, using an image generation model, an intermediate image based on the input image and the mask, wherein the intermediate image differs from the input image within the region indicated by the mask and is similar to the input image outside of the region indicated by the mask; and
combining the input image and the intermediate image to obtain a composite image, wherein the composite image includes content from the intermediate image within the region indicated by the mask and content from the input image outside of the region indicated by the mask.

17. The system of claim 16, wherein:
the image generation model performs a first phase of a diffusion process based on the mask and a second phase of the diffusion process independent of the mask.

18. The system of claim 17, wherein:
the first phase is based on a masking interval parameter and a sampling interval parameter.

19. The system of claim 16, wherein:
the image generation model comprises a control network configured to extract structural information from the input image, and wherein the structural information is provided as input to the image generation model.

20. The system of claim 16, further comprising:
an image segmentation model configured to segment the input image to obtain a plurality of masked regions.
